(19) United States
(12) Patent Application Publication
(10) Pub. No.: US 2025/0078514 A1
(43) Pub. Date: Mar. 6, 2025

(54) AI BASED INVENTORY CONTROL SYSTEM

(71) Applicant: Sean A. Hutchens, San Diego, CA (US)

(72) Inventor: Sean A. Hutchens, San Diego, CA (US)

(21) Appl. No.: 18/764,521

(22) Filed: Jul. 5, 2024

Related U.S. Application Data
(60) Provisional application No. 63/525,629, filed on Jul. 7, 2023.

(51) Int. Cl. G06V 20/52; G06Q 10/087; G06V 10/26; G06V 10/764; G06V 10/774; G06V 10/82; G06V 20/70

(52) U.S. Cl. CPC G06V 20/52; G06Q 10/087; G06V 10/26; G06V 10/764; G06V 10/774; G06V 10/82; G06V 20/70

(57) ABSTRACT

An AI based inventory control system. A first moveable drawer, the first moveable drawer moveable from a first position to a second position. A first camera arranged to generate an image of an inventory item contained within the first moveable drawer. An image processor in operative communication with the first camera, the image processor configured to process the image generated by the first camera. An AI engine performing recognition on the processed image received from the image processor.

### FIELD

The present disclosure relates generally to inventory control and/or inventory monitoring. More particularly, the present disclosure relates to methods, systems, and apparatus for detecting objects or visual features (such as text) and more particularly relates to methods, systems, and apparatuses for object detection using Artificial Intelligence, such as Machine Learning.

### BACKGROUND

Inventory control systems and methods may be used to monitor or track item usage during a given time period, such as during the day, during the week or during a work shift. For example, such items may include tools, instruments, medical supplies, medicaments, and other related items of use. Such systems and methods may also be used to identify when these items are taken from a particular location (e.g., such as a toolbox or other like storage system or mechanism) for use and also when they are returned from use.

Such systems and methods may also be utilized to monitor or record when these inventoried items are returned after they are used or removed from their original location within a particular location. Being able to track and monitor the flow of these types of items has certain advantages. As an example, such advantages include limiting item loss or limiting item theft. As just another advantage, such systems and methods may be used to track the amount of item or tool usage, thereby providing one measure of tool usage allowing the ability to gauge or provide suggested upgrades, item/tool updates, or indicate the need for additional training. These systems can also extend the useful life of certain items that might require periodic maintenance and/or recalibration.

In addition, such systems may also be used to record or monitor which items are being used and for how long these items are being used, in case certain such items will need maintenance or need for recalibration. Such systems and methods may also monitor and record which items are being used by whom, such as a particular person, technician, or mechanic.

Moreover, such systems and methods may be used to monitor the status of the item. That is, as just one example, whether a specific tool or instrument is in a functional or non-functional state. That is, if the tool or instrument is broken and needs to be replaced or perhaps needs refurbishing. These systems may also be used by certain users, operators, or administrators to assist in a determining if new items or tools may need to be ordered or repaired. In addition, such systems and methods may be configured to assist or play a role in the ordering of new items and equipment if it is determined that new items need to be ordered.

### SUMMARY

According to an exemplary arrangement, an AI based inventory control system for monitoring a status of a first item is disclosed. The system comprises a first moveable drawer, the first moveable drawer lockable in a first locked position and moveable from this first locked position to an unlocked position. A first camera arranged to generate an image of an item contained within the first moveable drawer. An image processor in operative communication with the first camera, the image processor configured to process the image generated by the first camera. An AI engine performs a recognition function on the processed image received from the image processor. In one arrangement, the recognition function comprises an image recognition function. In an alternative arrangement, the recognition function comprises a text recognition function.

According to one arrangement, the camera is configured to be movable along at least a portion of the first moveable drawer.

According to one arrangement, the AI engine performs object detection of the processed image received from the image processor.

According to one arrangement, the AI engine performs text recognition of the processed image received from the image processor.

According to one arrangement, the AI engine determines an inventory condition of the inventory item.

According to one arrangement, the AI engine identifies the inventory item residing in the first drawer and provides image recognition information for further processing by the AI based inventory control system.

According to one arrangement, the inventory item residing in the first drawer comprises a hand tool.

According to one arrangement, an AI based system for training an inventory control system comprises an AI graphics integrated circuit for operation of the AI based system; a camera positioned over an inventory item; a stepper motor operably coupled to the camera and controlled by the AI graphics integrated circuit, wherein the stepper motor is configured to move the camera to a plurality of positions; a plurality of images of the inventory item taken by the camera as the camera is moved to the plurality of positions; a processing software that processes each of the plurality of images of the inventory item; a labeling system defined in part by the inventory item, the labeling system generating a plurality of labeled images; a learning data set comprising the plurality of the labeled images of the inventory item; and a CNN based computer vision model for receiving the learning data set of the inventory item, wherein the CNN based computer vision model is trained to identify the inventory item based in part on the learning data set of the inventory item.

According to one arrangement, the CNN based computer vision model comprises a cloud-based computer vision model.

According to one arrangement, each of the plurality of images are labeled into a plurality of categories before being sent to the cloud.

According to one arrangement, each image is labeled with a part number before the image is sent to the cloud.

According to one arrangement, each inventory item is automatically labeled with the part number before the image is sent to the cloud.

According to one arrangement, the labeling system comprises a plurality of item classifiers.

According to one arrangement, the plurality of item classifiers comprises a hierarchical classification system.

According to one arrangement, the plurality of item classifiers are selected from a group of classifiers including category, type, class color, texture, pattern, contour, edge, writing, and dimension.

According to one arrangement, the processing software comprises an image segmentation algorithm that divides each of the plurality of images into regions that share a common characteristic.

According to one arrangement, the image segmentation algorithm converts each of the plurality of images to grayscale and imports the greyscale images into the CNN based computer vision model.

According to one arrangement, the inventory item is laid out on a size platform while the camera is provided at a predetermined height while creating the plurality of images, thereby creating a reference scale for the processing software.

According to one arrangement, the camera automatically takes the plurality of images at a plurality of different angles.

According to one arrangement, the integrated circuit comprises a SoC (system on a chip) designed for AI/graphics computations, and wherein the SoC comprises a CPU, a GPU, and a memory controller into a single chip.

The features, functions, and advantages can be achieved independently in various embodiments of the present disclosure or may be combined in yet other embodiments in which further details can be seen with reference to the following description and drawings.

[symbol]

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of an AI based inventory control system, according to an example embodiment;

FIG. 2 illustrates a cutout for use with an AI based inventory control system, such as the AI based inventory control system illustrated in FIG. 1,

FIG. 3 illustrates various component parts for use with an AI based inventory control system, such as the AI based inventory control system illustrated in FIG. 1;

FIG. 4 illustrates various component parts for use with an AI based inventory control system, such as the AI based inventory control system illustrated in FIG. 1;

FIG. 5 illustrates a perspective view of an AI based inventory control system, according to an example embodiment;

FIG. 6 illustrates an exemplary method of training a CNN for use with an AI based inventory control system, such as the AI based inventory control system illustrated in FIG. 5;

FIG. 7 illustrates another exemplary method of training a CNN for use with an AI based inventory control system, such as the AI based inventory control system illustrated in FIG. 5; and

FIGS. 8A and 8B illustrate another exemplary method of training a CNN for use with an AI based inventory control system, such as the AI based inventory control system illustrated in FIG. 5.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The present disclosure is generally related to the use of Artificial Intelligence (AI) for use with training an inventory control system. As just one example, such AI is used for training an AI based inventory control system for control of one or more items, such as a tool, an instrument (such as a medical instrument), a medical supply, a medicament container, or other similar type items. In one preferred arrangement, the AI system utilizes a machine learning engine for object identification and learning. In one preferred arrangement, the AI system utilizes a machine learning engine for text identification and learning. In one preferred arrangement, this machine learning engine comprises a Convolutional Neural Network (CNN).

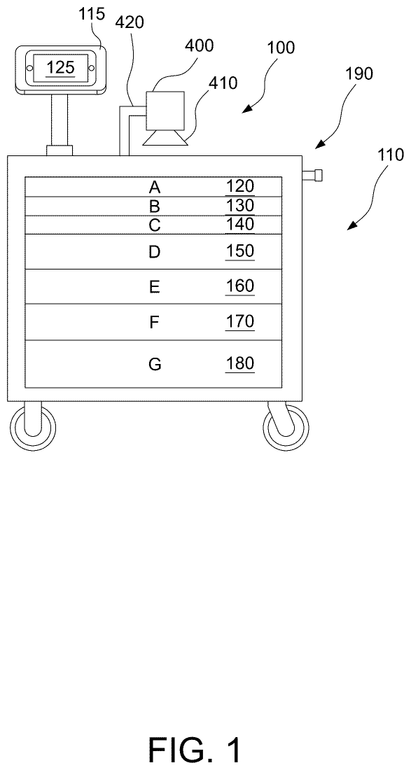

FIG. 1 illustrates a perspective view of an AI based inventory control system 100 according to an exemplary embodiment. As illustrated, the AI based inventory control system 100 comprises an AI based inventory control system for monitoring a status of a first item, such as a tool, an instrument, a utensil, a medical device, medical supplies, an appliance, or a hand-tool. As illustrated, the AI based inventory control system comprises an AI based inventory control system for monitoring and tracking a status of one or multiple items in one or multiple drawers of a container, such as a container 10 comprising multiple drawers, such as a toolbox for securely retaining a plurality of items.

For example, the multiple items comprise multiple instruments, appliances, or hand-tools, such as flashlights, hammers, screwdrivers, wrenches, files, awls, tape measures, and the like. However, as those of ordinary skill in the art will recognize, the container 10 may be configured or structured to contain other types of items such as medical instruments, medical supplies, medicament containers, or other items that may be required to be inventoried or tracked for one or more reasons.

The AI based inventory control system 100 comprises a structure or container or enclosure (e.g., a toolbox) comprising at least a first moveable drawer 120. The first moveable drawer 120 is preferably lockable in a first locked position. In other words, the contents of the first moveable drawer 120 cannot be accessed unless the drawer is placed within an unlocked or opened state. The first moveable drawer 120 is also moveable from this first locked position to an unlocked position. In the locked position, individuals cannot remove items contained within the drawer. In addition, in the locked position, individuals cannot return items back to a drawer. The toolbox may contain a number of sensing devices, like position sensors and actuators, that operate to detect various states of the toolbox and toolbox components, like whether a particular drawer is closed, whether a drawer is moving from an open to a closed position, whether the toolbox is locked, whether the toolbox is moving, among other items. A locked or lockable AI based inventory control system 100 may be beneficial where the stored items are valuable items (such as expensive work tools or medical instruments) or where the stored items are potentially harmful or dangerous items (such as medicaments).

Alternatively, in the unlocked position, authorized individuals can remove items contained within the drawer 120. In one preferred arrangement, the system can monitor the removal as well as the return of the various items contained in each of the drawers of this system. In one preferred arrangement, the system can monitor and can record the individual, or user or person removing as well as returning particular items within the system. In addition, in one preferred arrangement, the system 100 can also record when such items were returned as well as the state of the item upon its return. As just one example, an item's state may relate to whether the item needs maintenance, whether the item needs to be recalibrated, whether the item needs refurbishing, how many times a particular item has been withdrawn, or whether the item needs to be re-ordered as a new item.

As illustrated, in this particular control system arrangement, this control system includes seven (7) different drawers: 120, 130, 140, 150, 160, 170, and 180. In FIG. 1, these seven (7) different drawers are marked A-G. In one preferred arrangement, each drawer A-G within this container structure 110 may be structurally configured similar to one another. However, as will be described, each drawer A-G may be structured so as to contain either the same types of items or tools or perhaps structured so as to contain dissimilar types of items or tools. As those of ordinary skill in the art will recognize, alternative drawer configurations, structures, and internal drawer contents may also be utilized as well. As just one example, perhaps a first drawer may contain medical instruments for a certain medical procedure and a second drawer may comprise certain medicaments and medical supplies for use with the medical instruments contained within the first drawer. As those of ordinary skill in the art will recognize, alternative drawer arrangements, configurations, and content requirements may be utilized as well.

In one preferred arrangement, the system 100 further comprises a locking system or a drawer lock mechanism 190. Specifically, a locking system 190 for locking and unlocking the various drawers A-G contained within the AI based inventory control system 100. Such a locking system 190 can be used to prevent unauthorized access to the inventory system.

As an example, such a locking system 190 may comprise an electronic locking system. In an alternative arrangement, such a locking system 190 may comprise an electro-mechanical locking system. As just one example, such an electronic locking system 190 may comprise an electromagnetic locking system. For example, such an electromagnetic locking system may be utilized for locking the first moveable drawer 120 in a locked position. In yet an alternative arrangement, such an electromagnetic locking system can be utilized for locking all of the moveable drawers A-G in a locked position.

In one preferred arrangement, the locking system 190 may comprise a timed locking system. For example, in one arrangement, after a user properly logs into the AI based inventory control system, a computing device will send a signal to a digital controller and this digital controller will energize the proper magnetic lock within the system. In one arrangement, this energizing comprises a timed energization, for example for five (5) seconds. With such a timed energization, the unlocked drawer will remain unlocked for a certain period of time or time frame and the user will need to then pull out or open the drawer within this time frame. In other words, the user must open the drawer within this five (5) second unlocked period of time. If access to the drawer is not obtained within this time frame, the AI based inventory control system will re-lock the previously unlocked drawer.

In one arrangement, the system 100 includes an electromagnetic locking system that locks a second moveable drawer in a locked position. Similar to the first moveable drawer, the second moveable drawer is moveable from this second locked position to an unlocked position. In yet an alternative arrangement, a separate locking system may be utilized to lock just one drawer or alternatively lock a subset of multiple drawers.

As just one example, a first locking system may be utilized to lock a first and second moveable drawer 120, 130. Similarly, the inventory system may comprise a second locking system that is utilized to lock a third and a fourth moveable drawer 140, 150 within the same inventory system 100. These locking systems may operate either dependently of one another or independently of one another. In other words, unlocking certain drawers may or may not unlock all or some of the drawers residing in a particular container or toolbox.

In one arrangement, the electromagnetic locking system comprises a solenoid driver. In such a system, the solenoid driver may be operatively coupled to a solenoid. In such an exemplary system, activation of the solenoid driver energizes the solenoid to thereby allow the first moveable drawer to move from the first locked position to the unlocked position. Energizing this solenoid may also allow other moveable drawers within the container to become unlocked as well.

In order to monitor an inventory condition of one or more items contained within the container 110, a first camera system 400 is configured to reside on top of the toolbox or container 110. For example, the first camera system 400 may comprise a first camera 410 that is arranged external to the toolbox 110 and positioned such that it can take an image of the contents of a moveable drawer, such as the first moveable drawer 120. In one preferred arrangement, the first camera 410 can take an image of the contents of the first moveable drawer 120 if the first moveable drawer were in an open position. The first camera 410 may be configured so as to capture one or more images of an item to be identified, such as a hand tool. In addition, the first camera 410 may be configured so as to capture one or more images of certain text provided on an item to be identified, such as a label provided on a medicament vial or a medicament container or a medical supply.

The choice of camera for use as the first camera 410 depends on the specific requirements of the application, such as the desired resolution, frame rate, and field of view. As just one example, the first camera 410 may comprise a high-resolution camera so that it can capture more details in the item's image or the text, which can be important for detecting small objects and fine features. For example, the camera 410 may comprise a 1080p camera (1920×1080 pixels) can provide more detail than a 720p camera (1280×720 pixels). Although only one camera 410 is illustrated in the AI based inventory system 100 in FIG. 1, those of ordinary skill in the art will recognize alternative camera configurations comprising more than one camera may be utilized as well.

In one arrangement, the first camera 410 of the camera system 400 may be movable or configurable along the top portion of the toolbox as illustrated in FIG. 1. For example, in one preferred arrangement, the first camera 410 comprises a Digital Single-Lens Reflex (DSLR) camera, which are cameras commonly used for generating high-quality images with high resolution and low noise. In one preferred arrangement, they offer a range of lenses that can be used to capture images from different distances and angles.

In one arrangement, the camera comprises a SmartSens SC450AI, a 4 or 5 Megapixel CMOS Image Sensor. This Image Sensor is designed for AI cameras that require high performance in both day and night conditions. In one arrangement, this camera 410 comprises one or more of the following detailed technical specifications and/or features:
Resolution: 2704 (H)×1536 (V
Mega Pixels: 4 MP
Supply Voltage: 2.8 V (Analog), 1.2 V (Digital), 1.8 V (I/O)
Optical Format: 1/1.8 Inch
Package Type: CSP
Chroma: RGB
Shutter Type: Rolling Shutter
Frame Rate: 60 Frames/sec
ADC Resolution: 8 Bit, 10 Bit, 12 Bit
Pixel Size: 2.9 μm×2.9 μm
Dynamic Range: 87 to 100 dB
Sensitivity: 7072 mV/Lux-s
SNR: 42 dB
Sensor Technology: SmartClarity™
Interface: MIPI, DVP, LVDS
Physical Properties: 70-pin CSP package, Dimensions 8.63 mm×5.46 mm
Operating Temperature: −30 to 85 Degree C.

The SC450AI comprises BSI-enabled PixGain technology and SmartSens' full-color night vision technology, employing SFCPixel® technology to enhance sensitivity and reduce noise levels. This results in higher SNR and high-dynamic-range (HDR) image performance. The sensor is capable of delivering high-quality images even in low-light conditions and maintains performance in high-temperature environments.

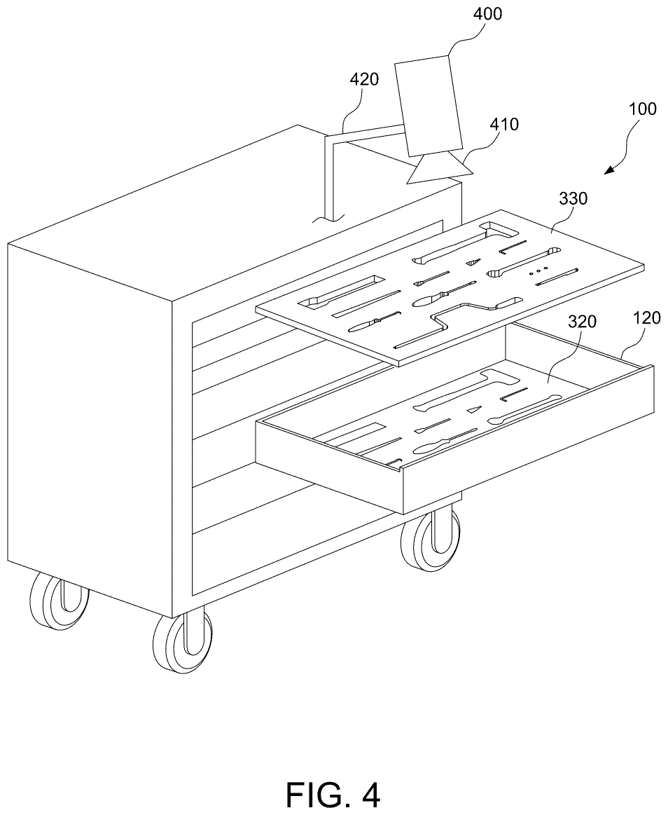

In one arrangement, and referring to FIGS. 1 and 4, the first camera 410 is configured to be movable along the toolbox 110, for example, it may be movable along the top surface of the toolbox 110. As just one example, the first camera 410 may comprise a DSLR camera configured on a movable arm 420 and can be used to capture a plurality of images of the various items that are contained within the various drawers A-G of the toolbox 110 in order to initially generate training data for a CNN in an object detection AI engine and/or text recognition AI engine. As just one example, the DSLR camera should have a high resolution and good low-light performance to ensure that the captured images are of high quality. As just one example, a camera with a wide-angle lens would also be useful for capturing images of the entire surface of a tool tray and respective instruments or tools contained within the various drawers in the container or toolbox. As yet another example, a camera with a wide-angle lens would also be useful for capturing images of an entire label and respective medicament containers contained within the various drawers in the toolbox 110 or item container.

The camera 410 can be mounted on the movable arm 420 which is positioned above the toolbox. For example, such moveable arm 420 may comprise an articulating arm or a robotic arm. For example, in one arrangement, the first camera 410 and the robotic arm 420 may be operatively coupled to the local computer device 115 or other computer device that can control the first camera's 410 movement and capture images. This can be done using a wired or wireless connection, depending on the specific hardware and software being used. In one arrangement, a plurality of server motors are used to provide controlled movement of the first camera 410 over the toolbox drawers wherein multiple images of the items seated within a foam cutout can be generated and/or processed.

In this manner, the computing device 115 can be programed so that the computing device 115 moves and operates the arm 420 over the top surface of a container drawers 120, 130, 140, 150, 160, 170, and 180. In this manner, the computing device 115 may be programmed so that it moves the camera 410 and operates the camera 410 so that the camera 410 captures a plurality of images of each drawer in the container 110 along with various items and contents. In one exemplary arrangement, image capture can be achieved using a pre-defined set of movements and image capture commands that can be programmed into the device's software.

In yet another preferred arrangement, the computing device 115 can also be programmed so as to adjust the camera settings to optimize the captured images. This may include adjusting the focus, aperture, shutter speed, and other settings to ensure that the images captured of the images contained within the toolbox drawers are of high quality and suitable for training a CNN in object detection and/or text recognition. In this manner, the first camera 410 will be able to capture images of each drawer 120, 130, 140, 150, 160, 170, and 180 in the container 110 from multiple angles and positions. Capturing such multiple images will help to ensure that the resulting images and hence AI training data is diverse and representative of the full range of variation in the items and their positions. Once the desired plurality of images have been captured, these images can be pre-processed and labeled using image processing software (as described in detail herein) in order to ensure that these images are ready for use in training a machine learning engine (e.g., a CNN) in object detection and/or text recognition.

As just one example, where the first item comprises an instrument, an appliance, or a hand tool (e.g., screwdriver), the camera will then send these images to an image processor for image processing. Processed images can then be forwarded to an artificial intelligence or a machine learning engine initially for CNN training purposes and then subsequently for image recognition purposes. This artificial intelligence engine can thereafter identify the tool residing in the first drawer and provide this image recognition information for further processing by the AI based inventory control system.

As another example, where the first item comprises a medicament container (e.g., a vial containing a medicament), the camera will then send these images to an image processor for text recognition. Processed images can then be forwarded to an artificial intelligence engine for CNN training purposes for text recognition purposes. This artificial intelligence engine can thereafter identify the medicament labeled as residing in the medicament container and provide this text recognition information for further processing by the AI based inventory control system.

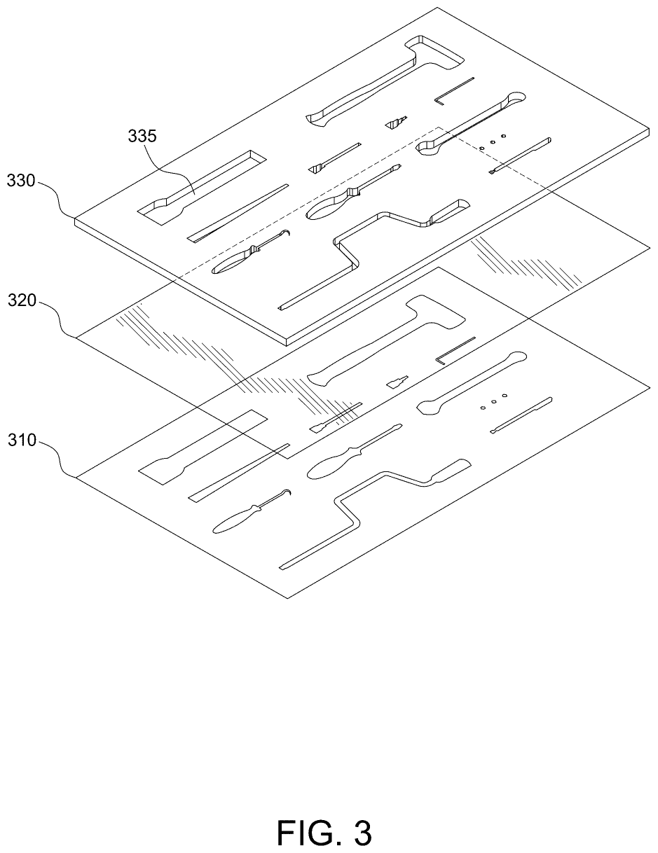

Turning to FIG. 3, the AI based inventory system 100 may further comprise a coating sheet 320 that is configured to be positioned over a surface of an alternative PCB/sensor board 310. For example, such a coating sheet 320 may comprise a coating sheet that comprises a multi-layered sheet. As just one example, such a coating sheet 320 may comprise a coating sheet that comprises a multi-layered plastic sheet. In one preferred arrangement, the coating sheet 320 comprises a four layered (PI) polyamide material having a thickness or about 0.1 millimeter.

FIG. 3 illustrates various component parts for use with an AI based inventory control system, such as the AI based inventory control system 100 illustrated in FIG. 1. Specifically, FIG. 3 illustrates the plastic coating sheet 320 residing between a foam cutout 330 and a sensor printed circuit board 310 (if one is provided). As noted, all three components 310, 320, 330 are shaped in a similar configuration. For example, all three components 310, 320, 330′ are rectangularly shaped and have similar geometrical configurations and dimensions. This will allow these various component parts 310, 320, 330 to be properly situated within a drawer of a container, such as a toolbox. As just one example, FIG. 4 illustrates how these component parts 310, 320, 330 are layered or positioned with respect to one another within a toolbox drawer.

The system 100 further comprises an overlay 330 that is positioned over a surface of the plastic coating sheet 320. As just one example, the overlay 330 comprises a foam overlay that defines at least one cut out or at least one recess 335 that conforms to the shape of an item, such as a hand-tool. In this illustrated arrangement, the at least one cut out 335 comprises an outline of the first item. The foam overlay 330 may also define multiple cut outs that conforms to an outline of other types of items. In one preferred arrangement, the foam overlay 335 comprises rigid ⅜″ thick extruded PVC that is fabricated by way of a waterjet cut. In one arrangement, the camera 410 will be utilized to generate multiple images while an item is seated within a representative, conforming cut out defined within the foam overlay 330.

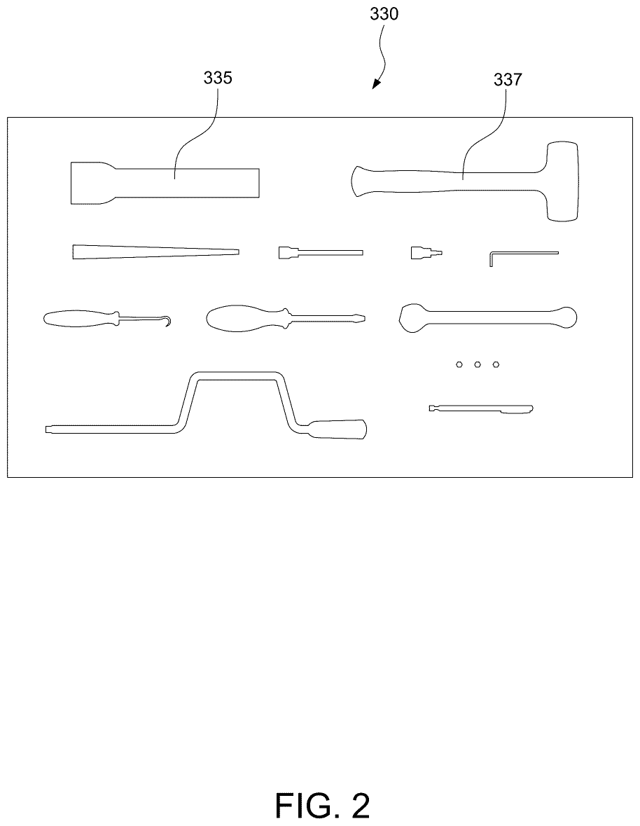

As just one example, FIG. 2 illustrates an exemplary foam overlay 330. As can be seen from FIG. 2, the foam overlay comprises eleven (11) cut outs defining multiple cut outs that conform to various outline shapes. For example, a first cut out 335 represents the shape of a flashlight and a second cut out 337 represents the shape of a hammer. Advantageously, the tool storage locations comprise a set of individually shaped recesses for receiving the tools. Such a structure can act to ensure that the items are returned to a proper and corresponding cut out. One benefit of such a structure is that it is possible for the system to identify which tools have been removed without having to utilize some type tagging devices on the tools.

Returning to FIG. 1, the AI based inventory control system 100 further comprises an image processing unit 115. The camera system 400 illustrated in FIG. 1 is operatively coupled to this image processing unit 115 and this image processing unit 115 is operatively coupled to a data display 125. This data processing unit 115 may or may not contain an AI engine for providing an image recognition and/or text recognition function for the image processed by the image processing unit 115.

In one preferred arrangement, the image processing unit 115 may be mounted directly or indirectly to the container 110 housing the drawers A-G. The data processing device 115 is operatively configured to receive images generated by or from the camera system 400 and has an output cable for transmitting signals to a computer having database software for maintaining an inventory of the tools in the container. The data processing device 115 may be in wired or wireless communication with a plurality of sensor devices (e.g., position sensors and/or actuators) contained within AI based inventory control system 100. In addition, the control unit can be connected to a remote computer or network wirelessly, for example via an infrared, radio or GSM link.

In one preferred arrangement, the data processing unit 115 is in operative communication with the first camera 410. In one preferred arrangement, the processing unit 115 comprises an ARM-Cortex-M4. The Cortex-M4 is a high-performance embedded processor developed to address digital signal control applications that demand an efficient, easy-to-use blend of control and signal processing capabilities. As those of ordinary skill in the art will recognize, alternative processors or processor arrangements can also be utilized.

In one preferred arrangement, the data processing unit 115 and its corresponding AI engine for image recognition may be used to process data to determine one or a plurality of inventory control parameters. As just one example, the data processing unit 115 may be configured to determine an inventory condition of the first item stored in the first moveable drawer 120. As just one example, the data processing unit 115 may be configured to determine an inventory condition wherein the inventory condition of the first item comprises an absent condition. That is, the data processing unit 115 can determine whether the first item resides within the first drawer 120 or whether the first item is absent from the first drawer 120.

Specifically, the data processing unit 115 and its corresponding AI image recognition engine can determine, with corresponding inputs from the camera system 400 and then processed by the image processing software, whether the first item resides within a specific cutout of a specific foam overlay 330 within the first drawer. The data processing unit 115 can also determine whether the first item is absent from a specific cutout of a specific foam overlay 330 within the first drawer 120. The data processing unit 115 can also determine whether the first item has been incorrectly placed within the specific cutout of the specific foam 330. That is, the data processing unit 115 can determine if an incorrect tool has been placed within a specific cutout. In addition, the data processing unit 115 can determine if a correct tool has been incorrectly placed within the correct specific cutout for that item. For example, this may occur where the item is incorrectly seated or not properly seated within the correct specific cutout for that item.

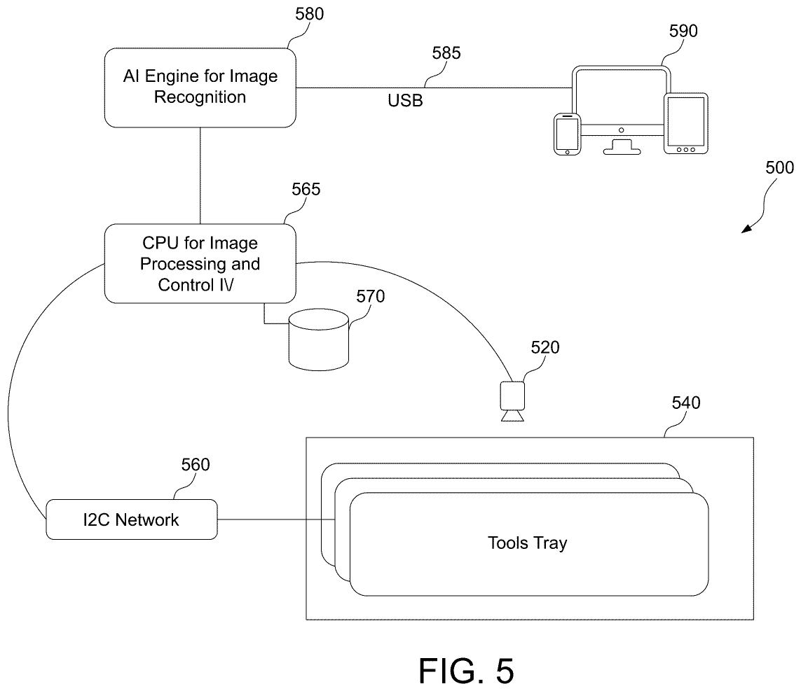

FIG. 5 illustrates a perspective view of various components of an alternative AI based inventory control system 500, similar to the AI based inventory control system 100 illustrated in FIGS. 1-4. As illustrated, the AI based tool management system 500 comprises a toolbox 540 comprising multiple trays within multiple drawers, similar to the toolbox configurations illustrated in FIGS. 1-4.

As illustrated, in one preferred arrangement, the inventory control system 500 comprises a camera-based machine learning system 520 that uses a convolutional neural network (CNN) AI engine 580 to learn different types of tools and/or different types of labeled items within a drawer of a toolbox 540, such as the toolbox illustrated in FIGS. 1-4. The CNN AI engine 580 comprises a deep learning neural network that performs certain tool image recognition and/or text recognition tasks. In this arrangement, the CNN AI engine 580 can be trained to recognize different types of tools by processing images of one or more tools that are contained with a tool trays contained within each toolbox drawer of the toolbox 540. In this arrangement, the CNN AI engine 580 can also be trained to recognize different types of text provided on various items by processing images of one or more labels that are provided by items contained within each toolbox drawer of the toolbox 540.

In one preferred arrangement, the camera system 520 is situated on the top of the toolbox 540. However, as those of ordinary skill will recognize, alternative camera system configurations may be utilized as well.

### Object Recognition

In order for the AI image or object recognition engine 580 to be able to recognize images of inventory items to a certain degree, the recognition engine 580 will need to be trained upon a number of images generated by the camera system 520 and then these images will need to be processed by the image processing CPU 565. To train the CNN based AI engine 580, a camera system 520 is used to first create a dataset of images of tools that can be collected and processed by the computing device CPU. These images can be stored in the corresponding storage devices, such as storage device 570 that is in one arrangement communicatively coupled to the image processing CPU. This communicative coupling may be a wired connection or a wireless connection.

In one preferred arrangement, these images can be labeled with the type of tool that is present in the image. With these labeled tool images, the CNN based AI engine 580 can be trained using a supervised learning approach. In such a supervised approach, where the AI engine 580 is shown a set of labeled images and adjusts its CNN's parameters to better recognize the different types of tools. As the CNN is trained over time by the various images captured by the camera system 520 and then processed by the CPU for image processing 565, the AI image recognition engine 580 gradually becomes better at recognizing different types of tools. And over a certain period of training time, the AI image recognition engine 580 can learn to differentiate between similar tools residing in the various tool trays within the various tool drawers of a toolbox 540, such as the toolbox illustrated in FIGS. 1-4.

Once the CNN based AI engine 580 has been adequately trained, this AI image recognition engine 580 can then be used to recognize tools within an image of a toolbox drawer. In one preferred arrangement, the camera system 520 comprises at least one camera as described herein. However, as those of ordinary skill in the art will recognize, more than one camera may be used. The camera-based machine learning system 520 can capture an image of the drawer and use the AI engine 580 to identify the different types of tools that are present. The system can then use this information to create an inventory of the tools in the drawer and make probabilistic determinations of object or tool recognition.

To make these probabilistic determinations, the AI based machine learning system 500 can use a probability distribution function that represents the likelihood of each tool being present in the drawer. The system can use the output of the CNN to calculate these probabilities, taking into account the similarity between different types of tools and the likelihood of a tool being present based on previous inventory records processed and stored during AI engine training.

Overall, a camera-based machine learning system that uses a CNN to learn different types of tools within a drawer of a toolbox can provide an efficient and accurate way to inventory tools and manage tool usage. By using probabilistic determinations of object recognition, the system can make more informed decisions about tool usage and help to reduce waste and improve efficiency in tool management.

### Text Recognition

In order for the AI text recognition engine 580 to be able to recognize text provided by inventory items to a certain degree, the recognition engine 580 will need to be trained upon a number of images generated by the camera system 520 and then these images will need to be processed by the image processing CPU 565. To train the CNN based AI engine 580, a camera system 520 is used to first create a dataset of images of texts that can be collected and processed by the computing device CPU. These images can be stored in the corresponding storage devices, such as storage device 570 that is in one arrangement communicatively coupled to the image processing CPU. This communicative coupling may be a wired connection or a wireless connection.

In one preferred arrangement, these images can be labeled with the type of text that is present in the image. With these labeled text images, the CNN based AI engine 580 can be trained using a supervised learning approach. In such a supervised learning approach, the AI engine 580 is shown a set of labeled images and adjusts its CNN's parameters to better recognize the different types of texts. As the CNN is trained over time by the various images captured by the camera system 520 and then processed by the CPU for image processing 565, the AI image recognition engine 580 gradually becomes better at recognizing different types of texts. And over a certain period of training time, the AI image recognition engine 580 can learn to differentiate between similar texts provided by the various items and tray items within the various drawers of a container 540, such as the toolbox illustrated in FIGS. 1-4.

Once the CNN based AI engine 580 has been adequately trained, this AI text recognition engine 580 can then be used to recognize text provided by certain items within a toolbox drawer. In one preferred arrangement, the camera system 520 comprises at least one camera. However, as those of ordinary skill in the art will recognize, more than one camera may be used. The camera-based machine learning system 520 can capture an image of the drawer and use the AI engine 580 to identify the different types of text and therefore text carrying items that are present. The system can then use this information to create an inventory of the text carrying items in the drawer and make probabilistic determinations of text recognition.

To make these probabilistic determinations, the AI based machine learning system 500 can use a probability distribution function that represents the likelihood of each text carrying item being present in the drawer. The system can use the output of the CNN to calculate these probabilities, taking into account the similarity between different types of texts and the likelihood of a particular item carrying text being present based on previous inventory records processed and stored during AI engine training.

Overall, a camera-based machine learning system that uses a CNN to learn text recognition for certain text carrying items within a drawer of a toolbox can provide an efficient and accurate way to inventory these items and manage item usage. By using probabilistic determinations of text recognition, the system can make more informed decisions about item usage and help to reduce waste and improve efficiency in item management.

### Cloud Based Text Recognition

In another preferred arrangement, the camera-based machine learning system will utilize a cloud-based image identification service. For example, this cloud based image classification service may comprise a cloud-based machine learning API. This cloud-based image identification service, among other services and tools, may provide various image analysis and recognition capabilities. In one preferred arrangement, this identification service can leverage advanced deep learning models to extract useful information from images, including the ability to parse out language from text within an image.

Provided below is a detailed explanation of how a cloud-based image identification services can be implemented as an image processing service by way of the presently disclosed systems and methods.

First, an image is uploaded. For example, the system illustrated in FIG. 4 uploads an image to the cloud-based image identification services API, either by providing a direct image file or specifying a publicly accessible URL. As presently disclosed, the system will provide an image containing a textual matter (e.g., a medicament or printed matter on a tool) to be identified, along with other types of non-medicament information.

Second, the system preprocesses the image. The uploaded image goes through preprocessing steps to enhance its quality and optimize it for analysis. This may involve resizing, color correction, and noise reduction techniques to improve the image's clarity and ensure accurate analysis.

Third, in one preferred arrangement, the cloud-based image identification service employs convolutional neural networks (CNNs) for feature extraction. These CNN models are trained on massive datasets to recognize and understand various visual patterns and structures within images. For example, the CNN may contain one or more low-level features. The initial layers of the CNN extract low-level features such as edges, textures, and color gradients. These features capture basic visual elements in the image.

As another example, the CNN may contain one or more high-level features. As the image passes through deeper layers of the CNN, the network captures more complex and abstract features. These high-level features represent more advanced visual concepts like shapes, objects, and patterns.

In a preferred arrangement, the cloud-based image identification services can identify and localize multiple objects within an image using a technique called object detection. By leveraging the learned features, the system can detect and classify different objects present in the image. It can provide bounding boxes around each detected object and assign labels to them, indicating the recognized object's category (e.g., language, a medicament name, person, car, dog).

Next, the image is analyzed to identify any textual content present, particularly for the presently disclosed inventory control system, the image is analyzed for one or more potential medicaments to be identified. In one preferred arrangement, the cloud-based image identification services employ optical character recognition (OCR) techniques to extract text from the image. The system looks for regions in the image that resemble text and then processes those regions to recognize and extract individual characters and words.

Once the text is extracted, in one preferred arrangement, the cloud-based image identification services will use natural language processing (NLP) techniques to parse and understand the language within the text. This involves tasks like language detection, sentiment analysis, entity recognition, and syntax analysis. For example, in one arrangement, the system determines the language in which the text is written. This is useful when processing multilingual content.

In one arrangement, the cloud-based image identification services can analyze the sentiment or emotional tone expressed in the text, determining whether it is positive, negative, or neutral. The API can identify different entities within the text, such as people, organizations, locations, dates, and more. In one arrangement, the cloud-based image identification services analyzes the grammatical structure and syntactic relationships within the text. It can identify parts of speech, dependencies between words, and sentence boundaries.

After analyzing the image and processing the language within it, the cloud based image identification service generates a response in a structured format, typically in JSON. The response includes various details such as detected objects, their locations, recognized text, language details, sentiment scores, and entity annotations. In one preferred arrangement, the cloud-based image identification services forwards with identified text to system for display and potential future analysis and/or storage. In one arrangement, the system may look up various instruments and other attributes for the identified medicament. These attributes will thereafter be forwarded to the user of the system for review and manipulation.

By leveraging the cloud-based image identification services' image analysis and language processing capabilities, developers can build applications that automatically extract meaningful information from images, enable image search, automate data entry from documents, and much more.

### I2C Network

In one preferred arrangement, the AI based inventory management system further comprises an I2C (Inter-Integrated Circuit) 560 that is communicatively coupled to the toolbox 540 and a CPU image processing system 565. In such an arrangement, the I2C 560 comprises a communication protocol that is used to exchange data between the toolbox 540 and the CPU image processor 565. In one preferred arrangement, this IC 560 comprises a two-wire serial bus that allows multiple devices to communicate with each other using a single communication line.

In one preferred inventory system, this I2C network 560 comprises a collection of devices connected together using the I2C protocol. The toolbox 540 and the CPU image processor 565 represent devices on this I2C network 560 that may be connected using two wires, a clock line (SCL), and a data line (SDA). The clock line is used to synchronize the data transfer between these devices 565, 540, while the data line is used to transmit and receive data.

In the illustrated AI based inventory system 500, in one preferred arrangement, the I2C network 560 can be used to connect various sensors contained within the toolbox 540 (e.g., for determining drawer locations and other relevant data) and other related toolbox electronic components to a microcontroller or a single-board computer within the CPU image processing device 565. As just one example, the toolbox 540 (as herein described) may contain various sensors and actuators that can be used to detect the position of various drawers contained within the toolbox, can detect the presence of tools within the various trays within the toolbox, along with providing other relevant information (e.g., tool tray identification data), such as the location and status of the tools.

### CPU for Image Processing and Control I/O

Image processing is an important task in an AI based inventory control system 500 that involves analyzing images of the inventory to identify the number and position of various tools contained within the toolbox 540. The AI based inventory control system 500 may also involve analyzing images of the inventory to identify text contained on one or more of the items within the toolbox 540. A CPU 565 can be utilized for image processing by executing specific image processing algorithms to perform various tasks, such as image segmentation, object detection, text identification, and classification.

In one preferred arrangement, the CPU image processor 565 may perform several image processing techniques. For example, it may perform image segmentation involving dividing an image received from the camera system 520 into distinct regions based on their characteristics, such as color or texture. This can help identify the location of the objects in the image. Object detection involves identifying specific objects within an image and providing information about their location and size. Classification involves determining the type of object present in the image, such as a tool or a part, based on its characteristics.

The CPU 565 can perform these tasks by executing specialized algorithms that utilize the power of the CPU's processing capabilities. In one arrangement, the CPU image processor 565 may also comprise a GPU (Graphics Processing Unit). As just one example, the CPU image processor can work in conjunction with a GPU to further enhance image and text processing capabilities.

Control I/O (Input/Output) can be a critical function in an AI based inventory control system 500 that involves controlling and monitoring various inputs and outputs, such as the camera arrangement, actuators, and other sensors within the system (e.g., within the toolbox). For example, the CPU 565 can be utilized for control I/O by communicating with the sensors and actuators through various communication protocols, such as I2C, SPI, and UART.

For example, the CPU can communicate with the camera system, readers and other sensors to detect the presence and location of objects in the inventory, process this information and then handoff this data and information to the AI engine for image and text recognition purposes. The CPU can then use this information to control the inventory management system by updating the inventory database and generating alerts if necessary.

The CPU can also communicate with actuators, such as motors and solenoids, to move objects within the toolbox or perform other control tasks, such as locking or unlocking the various drawers contained within the toolbox.

### USB Computing Device

Returning to FIG. 5, the system 500 further comprises an AI engine 580 for image recognition. This AI engine 580 receives its data from the image processing CPU 565, processes this data and provides an output over a communication line (e.g., a USB) 585 to one or more computing devices or a computing network.

The AI engine 580 processes this incoming data and then classifies objects and recognizes text based on the image processing that the CPU 565 performs on the images captured by the camera system 520 of the items contained within the inventor control system 500, such as the tool trays of the toolbox 540. In one preferred arrangement, the AI engine 580 comprises a convolutional neural network (CNN) that performs this classification function. CNNs have had success in the domain of object recognition, even exceeding human performance in some conditions. Convolutional neural networks can be highly proficient in extracting mappings of where high-level features are found within the tool images processed by the CPU. These feature maps may be extracted from convolutions on a static image and then be used for image, object, and/or text recognition.

In one AI engine arrangement, the CNN is a type of neural network commonly used for image-related tasks such as image classification, object detection, text, and/or image segmentation. The basic building blocks of this preferred CNN are convolutional layers and pooling layers. Convolutional layers are responsible for extracting features from the input image, while pooling layers reduce the spatial dimensions of the feature maps and help to prevent overfitting. In one preferred arrangement, the presently disclosed training apparatus comprises a plurality of convolution layers and a plurality of pooling layers as described in detail herein.

A typical CNN architecture for image classification consists of multiple convolutional layers followed by pooling layers, with fully connected layers at the end of the network to perform the final classification. In one preferred AI based inventory control system 500, the final tool classification would be the identification of an inventory item, such as a hand tool. The specific number and size of the convolutional and pooling layers, as well as the size and activation function of the fully connected layers, can depend on the specific type of item to be identified. As disclosed herein, a problem to be solved involves implementing the CNN to detect and then properly predict the nature of an inventory item, such as a tool to be maintained in an inventory system.

As disclosed herein, the apparatus will utilize one or more convolutional layers wherein each convolutional layer in a CNN applies a set of learnable filters to the input image, producing a set of feature maps that highlight different features in the image. The filters in the first convolutional layer will be configured so as to detect low-level features such as edges and corners, while subsequent layers detect higher-level features that are combinations of the lower-level features.

FIG. 5 illustrates an example AI based inventory control system 500 that may be used to automatically detect, classify, and/or localize items. The automated driving/assistance system may be used to provide an inventory control of one or more items or tools maintained within a toolbox and to provide assistance to an inventory administrator. For example, the AI based inventory control system 500 may control how items are checked in and checked out from inventory control. In another example, the AI based inventory control system 500 may provide notifications and alerts to assist an inventory administration as to when tools are in disrepair or need servicing. The AI based inventory control system 500 may use a neural network, or other model or algorithm to detect or localize objects based on perception data gathered by one or more sensors operating within the example AI based inventory control system. In one preferred arrangement, these one or more sensors comprise one or more cameras.

As noted, the AI based inventory control system 500 also includes one or more sensor systems/devices for detecting a presence of objects near or within a sensor range of a camera 520. For example, the control system may include one or more camera systems 520, or a global positioning system (GPS). The AI based inventory control system 500 may include a data store 570 for storing relevant or useful data for tool check out check in, and maintenance issues. In addition, the AI based inventory control system 500 may also include a transceiver for wireless communication with a mobile or wireless network, other computing device, other AI based inventory control systems or infrastructure, or any other communication system. In addition, the AI based inventory control system 500 may also include a transceiver for wireless communication with a mobile or wireless network, other computing device, other AI based inventory control systems or infrastructure, or any other communication system, such as communication by way of the cloud.

In one preferred arrangement, the presently disclosed AI engine may create or assign an AI engine to each inventory control system wherein this inventory control system may be allocated or provided with a unique identifier, such as a serial number. In such a scenario, this unique identifier or serial number may be shipped with the inventory control system as provided to an end customer. In one such arrangement, the provider or supplier of the inventory control system may maintain a master set of trained images or a principal library of trained images for use with a training system or training GPU. Maintaining such a master set of trained images (such as a library of about 40,000 to about 50,000 trained images) may provide a number of system advantages including at the following:

Improved Accuracy: A master set of trained images allows the AI engine to recognize and differentiate between inventory items with high precision, reducing errors in identification.

Speed and Efficiency: AI systems can quickly scan through the image library to find matches, speeding up the inventory tracking process and increasing overall efficiency.

Consistency: A principal library help to ensure that the AI system has a consistent reference, which can be crucial for maintaining uniformity across different instances of the inventory control system.

Ease of Integration: New items can be added to the inventory by simply adding their images to the library, making the integration process smoother and less time-consuming.

Scalability: As the inventory grows, the image library can be expanded without significant changes to the underlying AI algorithms, allowing the system to scale with ease.

Reduced Training Time: With a pre-existing set of trained images, the AI system requires less time to become operational, as it does not need to learn from ground zero.

Cost-Effectiveness: By minimizing the need for manual inventory checks and reducing the likelihood of errors, a principal library can lead to cost savings.

Data Enrichment: The image library can be enriched with metadata, providing additional context and information about each item, which can be used for more complex inventory tasks.

Machine Learning Optimization: The use of a standardized image set can improve the machine learning model's performance by providing high-quality, relevant data for training.

Customization and Flexibility: The library can be customized to include various angles and lighting conditions, ensuring robust item recognition under different scenarios.

Real-Time Updates: The AI system can be designed to update the principal library in real-time as new inventory items are introduced or existing items are modified.

Enhanced Decision Making: With accurate inventory data, businesses can make better-informed decisions regarding stock levels, ordering, and logistics.

In one such arrangement, the provider or supplier of the inventory control system may retain the AI engine internally, allowing the provider or supplier to make potential inventory control system layout or inventory item (e.g., tool) future changes that the end user may desire or make. In one preferred arrangement, these changes or modifications may be made wirelessly. Integrating an AI engine into a wireless or cloud based inventory control system can bring numerous benefits, especially when it comes to tracking and managing inventory with precision and flexibility. Such advantages may include at least one of the following.

Enhanced Tracking: By assigning a unique serial number to each inventory control system, an AI engine can track individual units with accuracy, helping to ensure that each item of inventory is accounted for.

Real-Time Updates: With wireless control capabilities, the AI engine can receive and implement software updates or changes to inventory items in real time, minimizing downtime and keeping the system current.

Adaptive Learning: AI engines can learn from inventory patterns and predict future trends, allowing for proactive restocking and reducing the risk of overstocking or stockouts.

Automated Optimization: The AI engine can automatically suggest optimizations for the layout of inventory items based on usage patterns, space utilization, and retrieval times, leading to increased efficiency.

Error Reduction: AI systems can significantly reduce human error in inventory management by automating data entry and analysis tasks.

Scalability: As the business grows, the AI engine can scale accordingly, managing larger volumes of inventory without a proportional increase in errors or oversight.

Cost Savings: By optimizing inventory levels and reducing manual labor, an AI engine can lead to significant cost savings over time.

Flexibility: The ability to modify the system wirelessly to include new inventory items or revise the layout means that the system can adapt quickly to changes in inventory or business practices.

Data-Driven Decisions: With the vast amount of data collected, AI can provide valuable insights for making informed decisions about inventory management.

Security: AI systems can include security protocols to prevent unauthorized access or tampering with inventory data.

Overall, the presently disclosed wireless based AI engine can transform an inventory control system into a dynamic, efficient, and intelligent operation, capable of adapting to the changing needs of a business

In one arrangement, the AI based inventory control system is configured to control access to the various tools and items contained within a container 540, such as the container illustrated in FIG. 1. For example, the AI based inventory control system 500 may control access to the toolbox 540 and may identify tools as they are checked in and checked out from the toolbox. The sensor systems/devices may be used to obtain real-time sensor data so that the AI based inventory control system 500 can assist with real-time tool identification and monitoring. The AI based inventory control system may implement an algorithm or use a model, such as a deep neural network, to process the sensor data to detect, identify, and/or localize one or more objects. In order to train or test a model or algorithm, a certain amount of sensor data and annotations of the sensor data may be needed.

In order for a neural network to be able to distinguish between certain desired classes, the neural network needs to be trained based on examples. In one preferred arrangement, training for each tool may occur and may take place by way of an automatic scanner that generates images from various heights and/or variable angles. As just one example, the automatic scanner may be based on a plurality of server motors and may spend about 5 minutes per tool to generate sufficient training images. As just one example, the automatic scanner may scan an entire item tray with items contained rather than be required to scan just the tools themselves.

Once the images with labels (i.e., training dataset) are acquired, the network may be trained. One example algorithm for training includes the back propagation-algorithm that may use labeled sensor frames to train a neural network. Once trained, the neural network may be ready for use in an operating environment, such as a tool AI based inventory control system and apparatus.

As described herein, in one preferred arrangement, it can be important to process the images captured by the one or more cameras 520 operating in the AI based inventory control system. Before labeled data is sent from the CPU image processor 565 to the AI engine 580 for image recognition, in one preferred arrangement, this labeled data may undergo one or more preprocessing steps to ensure that this labeled data is in a format that can be used by the CNN. These steps may include one or more of the following preprocessing steps.

Data cleaning: The labeled data may contain errors, missing values, or other issues that need to be corrected before this data can be used for training the AI engine 580. As just one example, this data cleaning step may involve removing outliers, filling in missing values, or correcting errors in the data.

Data normalization: To ensure that the data is consistent and can be compared across different samples, this data may be normalized to a common scale. This may involve scaling the pixel values to a range between 0 and 1 or standardizing the data to a mean of 0 and standard deviation of 1.

Data augmentation: To increase the diversity of the labeled data and improve the performance of the AI engine 580, data augmentation techniques may be used to create additional training examples. This may involve adding noise, rotating or flipping the images generated by the camera, or adjusting the brightness and contrast of the images.

Data splitting: In one preferred arrangement, the labeled data created by the CPU image processor may be split into training, validation, and test sets to evaluate the performance of the AI engine. In one arrangement, the training set may be used to train the AI engine, the validation set may be used to tune the hyperparameters of the model, and the test set may be used to evaluate the final performance of the model.

Label encoding: The labels associated with the labeled data are typically encoded in a format that can be used by the CNN. This may involve converting the labels to numerical values, one-hot encoding the labels, or using other encoding techniques.

Overall, the preprocessing steps that can be performed by the CPU processor 565 for labeled data helps to ensure that it is in a format that can be used by the AI engine 580 for image recognition. By cleaning the data, normalizing it, augmenting it, splitting it, and encoding the labels, the CNN of the AI engine 580 can be trained effectively and accurately to identify objects in images.

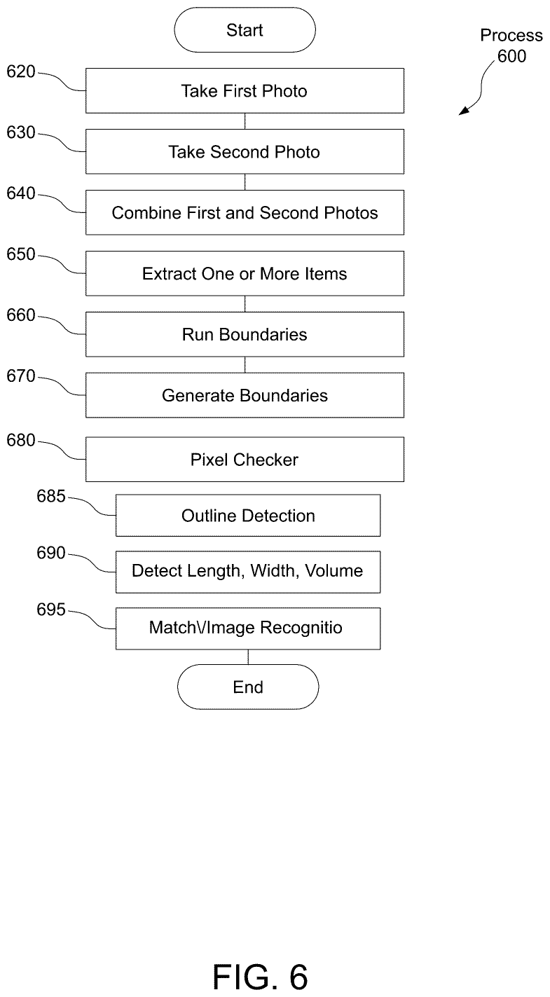

FIG. 6 illustrates one method 600 of implementing an AI engine for use with an AI based inventory control system, such as the systems illustrated in FIGS. 1-5. In one preferred arrangement, and as illustrated in FIG. 5, the system utilizes one or more cameras (in one arrangement, the method 600 compiles two images into one) by using two cameras. So, at step 620 a first image is taken and at step 630 a second image is taken. In one preferred arrangement, these two camera images will then be combined into a single labeled image at step 640. Using a two-camera system for image identification in a CNN based AI image recognition engine, such as the AI image recognition engine illustrated in FIG. 5, can provide several advantages.

Improved accuracy: With two cameras, images of the same item or tool can be captured from multiple angles. This can, in certain situations, provide more information about the object's shape and features. This can improve the accuracy of the CNN system's object recognition capabilities.

Greater coverage: In certain arrangements, two cameras can cover a wider area than a single camera, allowing for the capture of images from multiple angles and positions. This can be particularly useful for identifying objects in large areas, such as multiple tools contained in larger AI based inventory control systems having multiple storage locations or storage drawers.

Redundancy: If one camera fails or is obstructed, the other camera can continue to capture images, providing redundancy and ensuring that object recognition capabilities are not completely lost.

Better depth perception: With two cameras, it is possible to create a stereoscopic view, which provides depth perception and can improve the accuracy of the system's object recognition capabilities. This can be particularly useful for identifying objects in three-dimensional space, such as in robotics applications.

Improved performance in low-light conditions: By using two cameras with different sensitivities to light, it is possible to capture images in low-light conditions with better accuracy and clarity than with a single camera. Overall, using a two-camera system for image identification in the proposed CNN based tool inventory systems can provide several advantages over a single-camera system, including improved accuracy, greater coverage, redundancy, better depth perception, and improved performance in low-light conditions.

After step 630, the process 600 proceeds to step 650 where one or more images are extracted from the combined image. Next, the process 600 proceeds to step 660 where the algorithm runs a boundary generator and then at step 670 a boundary is generated to determine the potential boundaries for each item in the images.

In order to extract each object from an image for use in the presently disclosed convolutional neural network (CNN) based AI based inventory control system, in one preferred arrangement, a process called object detection is used. Object detection is the process of identifying the location and extent of objects within an image.

In one preferred arrangement, one system approach for object detection will be based on a region or boundary based convolutional neural network (R-CNN) method. This method may involve one or more of the following steps.

Selective Search: The image is initially divided into smaller regions using a selective search algorithm. This algorithm identifies regions of the image that have similar texture, color, or intensity, and groups them together.

Region Proposals: From the selective search results, a set of region proposals are generated, which are potential object locations within the image.

Feature Extraction: Each region proposal is passed through a pre-trained CNN to extract features that describe the contents of the region.

Object Classification: The extracted features are used to classify each region proposal as either containing an object or not.

Bounding Box Refinement: If an object is detected within a region proposal, the bounding box of the object is refined to more accurately fit the object.

Non-maximum Suppression: To avoid duplicate detections of the same object, a non-maximum suppression algorithm is used to select only the most confident detection for each object.

Running and generating a boundary generator for each image at boundary steps 660, 670 can be an important step in object recognition in the presently disclosed CNN based AI based inventory control system. For example, in the presently disclosed CNN based system, images may be first passed through a series of convolutional layers to extract features. These features are then used to identify objects in the image. However, in order to accurately recognize the objects, it is important to first determine the boundaries of the objects in the image. As noted, this step occurs at step 660 in FIG. 6.

To generate a boundary generator, the CNN system must be trained on a dataset of labeled images. As described herein, the training process involves adjusting the weights of the neural network of the AI engine to minimize the difference between the predicted boundary and the true boundary of the objects in the image.

Once the boundary generator is generated at step 660, it can be used to run the CNN on new images. The CNN first extracts the features of the image and then uses the boundary generator to identify the boundaries of the objects in the image. The identified boundaries can then be used to accurately recognize and classify the objects in the image.

Overall, running and generating a boundary generator for images in a CNN system can be an important step in object recognition as it allows the system to accurately identify the boundaries of objects in the image and improve the accuracy of object recognition.

In one preferred arrangement, the method 600 proceeds to step 680 where the process utilizes a pixel checker. For example, in one image processing arrangement, the pixel checking step 680 refers to the process of identifying and locating specific pixels or groups of pixels within a tool image. In one preferred arrangement, pixel detection 680 may be accomplished using various techniques such as thresholding, edge detection, and template matching. One purpose of pixel detection is to extract information from the tool image or to identify certain features of interest.

In an alternative arrangement, the image detection process 600 may utilize a pixel checker. A pixel checker comprises a tool or software that checks the quality of individual pixels or groups of pixels in a tool image. This is often done to identify any defects, errors, or inconsistencies in the image or video. The purpose of a pixel checker is to ensure that the image or video is of high quality and to identify any issues that need to be corrected.

Returning to the method 600 illustrated in FIG. 6, the method 600 proceeds to the step 685 which comprises the step of detecting an outline for each tool image. Outline detection can be important for a number of reasons, including at least one of the following.

Better object recognition: By detecting the outline or boundary of an object in a tool image, a CNN can more accurately recognize and classify the object. As just one example, the boundary can provide important contextual information about the object's shape, size, and orientation.

Improved segmentation: Image segmentation, which involves dividing a tool image into different regions or segments, can be improved by detecting the outline of objects in the tool image. This can be particularly useful for separating objects that are close together or overlapping.

More precise localization: By detecting the outline of an object, a CNN can more accurately localize the object within the image. This can be important for applications such as object tracking, where it is necessary to determine the location of an object over time.

Better understanding of object properties: By analyzing the outline of an object, a CNN can gain a better understanding of its properties, such as its shape, texture, and contour. This can be useful for applications such as object recognition, where it is necessary to identify objects based on their visual properties.

Improved generality: By detecting the outline of objects in an image, a CNN can become more generalizable to new or unseen objects. This is because the outline provides important information that is relevant to many different types of objects and can be used to identify objects in a variety of contexts.

Overall, detecting the outline for each image in a CNN is important for improving object recognition, segmentation, localization, understanding of object properties, and generality.

Next, the method 600 proceeds to the step 690 of detecting length, width, and volume (area under outline) from a tool image. In one arrangement, a one inch square on the foam cut out tray is used to reduce processing time for detection by allowing the AI algorithm to apply mathematical changes to various inventory items rather than processing changes to each individual item. In such an arrangement, the AI algorithm can detect displacement of the cut our tray or the camera, Detecting these image parameters can be important for CNN object recognition purposes for several reasons including at least one of the following.

Improved accuracy: Length, width, and volume provide important information about the size and shape of an object. This information can be used to improve the accuracy of object recognition, as it allows the CNN to differentiate between objects of different sizes and shapes.

Better classification: Length, width, and volume can be used as features to classify objects into different categories. For example, the length and width of a certain hand tool can be used to distinguish it from a larger tool or a non-tool item.

Object tracking: Length, width, and volume can also be used to track objects over time. By measuring these properties, a CNN can determine the trajectory and movement of an object, which can be useful for applications such as surveillance and autonomous vehicles.

Object segmentation: Length and width can be used to segment an image into different regions based on the size of objects. This can be useful for separating large objects from small ones, or for identifying objects that are too small to be detected by other methods.

Object recognition in different perspectives: Length, width, and volume can be used to recognize objects in different perspectives, such as when an object is partially obscured or viewed from an angle. By measuring these properties, a CNN can better understand the size and shape of an object, even when it is not fully visible.

Overall, detecting length, width, and volume from an image can be important for CNN object recognition purposes, as it provides important information about the size and shape of objects that can be used to improve accuracy, classification, tracking, segmentation, and recognition in different perspectives.

And then finally, the method 600 proceeds to step 695 where the processed image data is passed on to the AI engine for matching all of the input information and extracted image information against reference tool data. When accomplished by way of a CNN, this matching process can involve a series of steps including at least one of the following.

Preprocessing the input data: The input data, which may include images, videos, or other types of data, needs to be preprocessed before it can be used for matching against reference data. This may involve resizing images, converting data into a specific format, or normalizing data to account for differences in lighting, color, or other factors.

Extracting features from the input data: The CNN needs to extract features from the input data that can be used to match against reference data. This involves using a series of convolutional layers to detect edges, shapes, and other features in the input data, followed by pooling layers to reduce the dimensionality of the features and make them easier to process.

Comparing the extracted features to reference data: Once the features have been extracted from the input data, they can be compared to reference data using a variety of techniques. This may involve using distance metrics such as Euclidean distance or cosine similarity to compare feature vectors or using machine learning algorithms such as nearest neighbor or support vector machines to classify the input data based on its features.

Refining the match: If a match is found between the input data and the reference data, the CNN may refine the match by comparing additional features or using other techniques to improve the accuracy of the match.

Outputting the result: Once a match has been found and refined, the CNN can output the result, which may include information about the identity of the object in the input data, its location, or other relevant information.

Overall, matching the input information and extracted image information against reference tools data in a CNN involves a combination of preprocessing, feature extraction, comparison, refinement, and outputting the result. This process can be highly effective for identifying objects in images or videos and can be used for a wide range of applications, including surveillance, object recognition, and autonomous vehicles.

In one preferred arrangement, the AI learning engine will comprise one or more pooling layers. Such pooling layers are used to reduce the spatial dimensions of the feature maps while preserving the most important features. In one preferred arrangement, the pooling comprises max pooling, where the maximum value in a rectangular neighborhood of the input feature map is taken as the output.

Fully connected layers at the end of the network take the flattened output from the last pooling layer and use it to make a final classification decision. These layers typically use activation functions such as ReLU or sigmoid to introduce non-linearity into the network.

One of the reasons CNNs use activation functions such as ReLU or sigmoid is to introduce non-linearity into the network. Non-linearity is important in neural networks because it allows these networks to model complex relationships between inputs and outputs. Without non-linearity, a neural network would be limited to linear transformations, which may not be powerful enough to solve many real-world problems.

In one preferred CNN arrangement, the input to the convolutional layer comprises a three-dimensional tensor representing an image, with dimensions for height, width, and depth (number of channels). During the forward pass, the convolutional layer applies a set of filters (also known as kernels) to the input, producing a set of feature maps that represent different aspects of the input image. Each element of a feature map is the result of a convolution operation between the filter and a corresponding portion of the input.

After the convolution operation, the output of the convolutional layer is typically passed through an activation function. The activation function introduces non-linearity into the network by transforming the output of the convolutional layer using a non-linear function. ReLU (Rectified Linear Unit) and sigmoid are two common activation functions used in CNNs.

In the present apparatus and methods disclosed herein, either the ReLU or sigmoid activation functions may be utilized. As just one example, the ReLU activation function is defined as f(x)=max(0, x). It represents one type of computationally efficient function that is used in deep learning. ReLU is attractive for use in CNNs because it introduces non-linearity while also preserving the sparsity of the data. Sparsity means that many of the elements in a feature map are zero, which can be exploited to reduce the computational cost of the network.

In an alternative arrangement, the present systems and methods will utilize a sigmoid activation function. Such a sigmoid activation function may be defined as f(x)=1/(1+exp(−x)). In one illustrative arrangement, it represents a smooth, sigmoid-shaped function that maps the output of the convolutional layer to a range between 0 and 1. Sigmoid is used in some CNN architectures, but it is less common than ReLU. One advantage of sigmoid is that it is bounded, which can be useful in some applications where it is important to limit the output to a specific range.

In one preferred arrangement, this ReLU or sigmoid is followed by a SoftMax layer to output class probabilities. A SoftMax layer is often used as the last layer in a preferred CNN architecture to output class probabilities for multi-class classification problems. The SoftMax function is a generalization of the logistic function, which maps the output of the previous layer to a probability distribution over the classes.

In one disclosed CNN arrangement, the output of the last convolutional layer is fed into one or more fully connected layers. The fully connected layers are used to learn high-level representations of the input, which can then be used to classify the input into one of several classes. The output of the last fully connected layer is a vector of real numbers, which are often called logits. The logits represent the unnormalized scores for each class and are not directly interpretable as probabilities.

The SoftMax function is applied to the logits to obtain a probability distribution over the classes. The SoftMax function is defined as follows:

$$P\_i = {e}^{⋀} ( z\_i ) / ( sum ( {e}^{⋀} ( z\_j ) ) for j = 1 to n )$$

where P_i is the probability of the input belonging to class i, z_i is the i-th element of the logits vector, and n is the number of classes. The SoftMax function ensures that the output probabilities are between 0 and 1 and sum up to 1, which makes them interpretable as probabilities.

The SoftMax layer is trained using cross-entropy loss, which measures the difference between the predicted probabilities and the true labels. During training, the network adjusts the weights and biases of the fully connected layers to minimize the cross-entropy loss. In this way, the SoftMax layer encourages the network to output high probabilities for the correct class and low probabilities for the incorrect classes.

The use of a SoftMax layer to output class probabilities is important in many applications, such as image classification and object detection. The probabilities output by the SoftMax layer can be used to make decisions based on the input, such as identifying the most likely class or detecting multiple objects in an image. Additionally, the probabilities can be used to quantify the uncertainty of the network's predictions, which can be useful in applications where the consequences of a wrong prediction are high.

Overall, the construction of a CNN involves determining the number and size of the convolutional and pooling layers, as well as the size and activation function of the fully connected layers, based on the specific problem being solved. The network is then trained using backpropagation and gradient descent to optimize the weights of the filters and fully connected layers to minimize the loss function.

In one preferred arrangement, the CNN optimized for use with within the AI image recognition engine as disclosed herein can be represented by the following neural network architecture:
Input: 224×224×3
Convolutional Layer 1: 224×224×64
Activation: ReLU
Max Pooling: 112×112×64
Convolutional Layer 2: 112×112×128
Activation: ReLU
Max Pooling: 56×56×128
Convolutional Layer 3: 56×56×256
Activation: ReLU
Max Pooling: 28×28×256
Convolutional Layer 4: 28×28×512
Activation: ReLU
Max Pooling: 14×14×512
Convolutional Layer 5: 14×14×512
Activation: ReLU
Max Pooling: 7×7×512
Fully Connected Layer 6: 4096 neurons
Activation: ReLU
Fully Connected Layer 7: 4096 neurons
Activation: ReLU
Fully Connected Layer 8: 1000 neurons
Activation: Softmax
Output: 1000 probabilities, corresponding to the 1000 classes in the dataset

This is a description of a proposed convolutional neural network (CNN) architecture, which is used in an exemplary AI based inventory control system, such as the AI based inventory control system 500 illustrated in FIGS. 1-5 and is premised in an AI image classification engine.

Generally, this architecture or description provides the dimensions of the input data and each layer of the CNN. The input data has a size of 224×224×3, which means that it has a width and height of 224 pixels and 3 color channels (red, green, and blue).

In this illustrated arrangement, the CNN architecture comprises five convolutional layers (Convolutional Layer 1 to 5) with increasing depths of 64, 128, 256, 512, and 512, respectively. Each convolutional layer is followed by a rectified linear unit (ReLU) activation function to introduce non-linearity into the network.

After each convolutional layer, there is a max pooling layer that reduces the spatial dimensions of the feature maps by half, while retaining the depth. The max pooling operation selects the maximum value within each pooling window, which helps to reduce the computational complexity and improve the network's ability to generalize to new images.

After the fifth convolutional layer, there are three fully connected layers (Fully Connected Layer 6 to 8) with 4096 neurons each. These fully connected layers enable the network to learn complex relationships between the features extracted by the convolutional layers. Each fully connected layer is followed by a ReLU activation function, except for the last layer, which uses the SoftMax activation function.

The SoftMax activation function outputs a probability distribution over the 1000 classes in the dataset, indicating the likelihood that the input image belongs to each class. The output of the network has a size of 1000 probabilities, corresponding to the 1000 classes in the dataset.

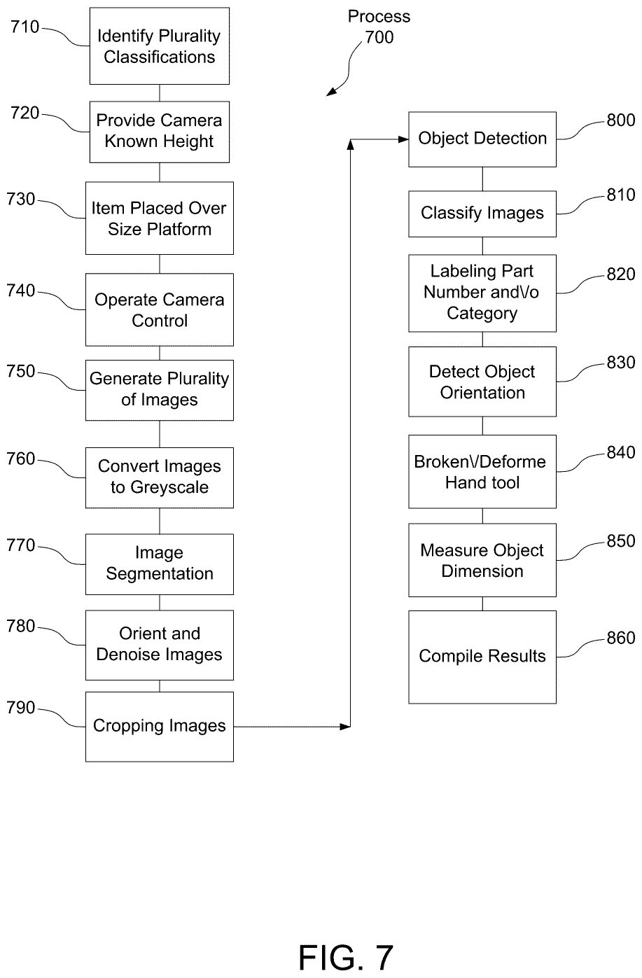

FIG. 7 illustrates another exemplary method or process of training a CNN for use with an AI based inventory control system, such as the AI based inventory control system illustrated in FIG. 5.

This method 700 begins at step 710 where the method or process identifies a plurality of classifications or labels that the engine will need to take into account before it can identify the inventory item. As just one example, the training of the CNN for use with an AI based hand tool inventory control system, such as the inventory control systems and methods described herein. In one illustrated arrangement, these classifications may comprise a plurality the categories, types, and/or classes of the inventory item, (such as a hammer, a pair of pliers, a flash light); the color, texture, pattern, contour or edge of the item; if there is any writing on the items such as a label identifying the item, and then; the dimension or the size of the item.

Defining a plurality of classifications requires a fair amount of computing power when analyzing whether the inventory item or tool is present. In order to expedite the processing of the disclosed system, in one arrangement, a system on a chip is utilized, such as the SoC provided and offered for AI/graphics computations where the SoC will look at each tool in a fraction of a second to make an identification. In one preferred arrangement, the identification engine will be based on an AI engine or computer vision model, such as YOLOv8.

### AI Engine or Computer Vision Model (Identification Engine)

Yolo 8—YOLO stands for You Only Look Once, and it is a popular and fast algorithm for detecting objects in images. YOLOv8 is a state-of-the-art computer vision model that can detect and locate multiple objects in images in real time. It is based on a deep neural network that uses advanced architectures and algorithms to extract features and perform calculations. YOLOv8 can detect hundreds of object classes, such as animals, vehicles, and people, as well as custom classes, such as hand tools.

Generally, to train an AI recognition engine or computer vision model such as YOLOv8, the following steps can be performed. First, a dataset of labeled images needs to be prepared. These labeled images will contain the objects or inventory items (e.g., hand tools) that need to be detected or identified. In preferred arrangement, the AI based inventory control system creates a dataset of labelled images and these images will be labeled in accordance with a plurality of identified classifications.

After this data set is created, the AI based inventory system will export the created inventory control dataset in a format that is compatible with the computer vision model of choice. Such formats may comprise YAML, JSON or other similar data formats.

YAML and JSON are two data formats that can be used to store and exchange structured information. YAML stands for YAML Ain′t Markup Language, and JSON stands for JavaScript Object Notation. Both formats use key-value pairs to represent data, but they have some differences in syntax and features. For example, YAML allows comments, supports multiple data types, and uses indentation to show hierarchy, while JSON does not allow comments, supports fewer data types, and uses braces and brackets to show hierarchy.

In one preferred arrangement, the presently disclosed computer vision model can perform various tasks such as object detection, image classification, and instance segmentation. It uses YAML and JSON files to configure its settings and hyperparameters. For example, a YAML file can define the model architecture, the data file, the number of epochs, the batch size, and the image size. A JSON file can define the class names, the anchor boxes, the loss function, and the optimizer. These files can be modified or customized to train YOLOv8 on different datasets or tasks.

Next, the AI based inventory control system will then train the model on the inventory control dataset. To properly perform this training function, various hyperparameters may be implemented, such as the learning rate, the batch size, the number of epochs, and the image size. These are some of the hyperparameters that affect the performance and efficiency of a CNN based computer vision model, such as YOLOv8.

For example, the learning rate controls how much the model's parameters are updated at each step of gradient descent. A good learning rate can help the model converge faster and avoid getting stuck in local minima. A bad learning rate can cause the model to diverge or oscillate around the optimal solution.

The batch size defines how many samples are used in one iteration of gradient descent. A larger batch size can reduce the variance of the gradient estimates and make the training more stable. A smaller batch size can increase the diversity of the samples and make the model more generalizable.

The number of epochs defines how many times the model goes through the entire training dataset. A higher number of epochs can help the model learn more complex patterns and reduce the training error. However, it can also increase the risk of overfitting and the computational costs.

The image size defines the resolution of the input images that the model processes. A larger image size can provide more details and features for the model to learn from. However, it can also increase the memory and computational requirements and the difficulty of the task. It is preferred that these hyperparameters need to be tuned carefully and empirically to achieve the best results for a specific task and dataset.

After the AI model has been initially trained, the system may be utilized to evaluate the performance of the model on a validation dataset or test dataset. That is, the system can be utilized to measure the accuracy and quality of the trained model. Once trained and tested, the system can then be deployed on a desired platform, such as an AI based inventory control system as herein described and illustrated.

### System on a Chip (SoC)

In one preferred arrangement, the AI based inventory control system utilizes an integrated circuit in the form of a SoC (system on a chip) that is designed for AI/graphics computations. The SoC comprise a graphics integrated circuit that comprises multiple components of a computer system, such as a central processing unit (CPU), a graphical processing unit (GPU), a memory controller, along with other peripherals, into a single chip. A main purpose of such a SoC is to perform complex and intensive tasks related to artificial intelligence and graphics processing, such as machine learning, computer vision, image processing, gaming, and rendering.

A SoC designed for AI/graphics computations as described herein operates by using specialized hardware units and software algorithms to process large amounts of data and perform various calculations. For example, in one preferred inventory control system, a SoC may use a CPU to run the operating system and the applications, a GPU to handle the graphics and parallel computations, and an AI accelerator to execute the computer vision model. As those of ordinary skill in the art will recognize, alternative integrated circuit configurations and arrangements may also be utilized.

A SoC designed for AI/graphics computations has several advantages over a traditional multi-chip architecture. A few of these advantages are summarized below.

Lower power consumption: By integrating multiple components into a single chip, the SOC reduces the power consumption and the heat dissipation of the system, which is important for mobile and battery-powered devices.

Smaller size: By reducing the number of chips and the interconnections between them, the SOC reduces the size and the weight of the system, which is beneficial for portable and compact devices and systems.

Higher performance: By optimizing the design and the communication of the components, the SOC increases the performance and the efficiency of the system, which is essential for demanding and real-time applications.

### Step 720—Camera Positioning

Returning to the method 700 illustrated in FIG. 7, after establishing a plurality of classifications at step 710, the training process 700 proceeds to step 720 where the camera is properly positioned as to generate a plurality of images. The training process 700 will proceed to step 720 where a system for camera control will be operated and wherein the camera will be provided at a known height. The camera may comprise at least one camera or a camera system (i.e., a plurality of cameras) as herein described with reference to FIGS. 1-6. In one preferred arrangement, the camera and/or camera system will be provided on a stand residing over the inventory item. In one arrangement, the camera will be operatively configured to be moved or manipulated to various positions or locations over or near the inventory item. As just one example, the camera may be operatively coupled to a stepper motor system. The stepper motor system will operate to position or maneuver the camera so as to take various photos or images of the inventory item at different heights and/or different angles.

### Inventory Item Positioned Over a Size Platform

In one preferred arrangement, the inventory item is placed over a sizing reference tool or size platform and this occurs at process step 720. One possible reason why you would place an inventory item laid out adjacent to a known size platform with the camera at a known height is to create a reference scale for the image recognition software or processing software. As just one example, by knowing the dimensions of the platform and the distance of the camera, the image recognition software can calculate the size of the inventory item in the image using various known geometrical equations and calculations. This can give the system a size determination for the inventory item, which can be useful for inventory management and planning.

In one exemplary arrangement, the size platform may comprise a flat surface comprising a fixed and known length and width, and that can be used as a reference scale for measuring the size of other features or characteristics in an image (i.e., the inventory item). In one arrangement, the platform may have a distinct color or pattern that can be detected and separated from the background and the object of interest. In one arrangement, the platform may have various distinct colors and/or patterns that can be detected and separated from the background and the object of interest thereby increasing the overall dataset of the training images. For example, in one arrangement, various images may be produced wherein the background color may be adjusted, changed, and/or modified for each image created or generated. As those of ordinary skill in the art will recognize, alternative color arrangements, backgrounds and/or image generation schemes and methods may be utilized as well.

In one arrangement, to use a known size platform for image recognition, the object to be measured is placed next to the platform and then the system is operated so as to take a picture of both of them from a fixed and/or known height. In one preferred arrangement, the height of the camera may be perpendicular to the platform and the object, and the distance between the camera and the platform may be greater than the length of the platform. This will help to ensure that the perspective distortion is minimal and that the platform and the object are visible in the image.

Then, an image recognition software or algorithm can be used to process the image and extract the dimensions of the platform and the object. Tools like OpenCV or YOLOv8 may be used to perform this task. The software or algorithm should be able to detect the edges and corners of the platform and the object and calculate their pixel coordinates and lengths. In one arrangement, the system uses the ratio between the pixel length and the real length of the platform to convert the pixel length of the inventory object to its real length, thereby determining the size of the object in the image.

### Step 730—Generating Various Images

Returning to the method 700 illustrated in FIG. 7, after establishing the camera position at step 720, the training process 700 proceeds to step 730 where the method the item to be trained on various items (i.e., hand tools). In one preferred arrangement, the training process includes the step of taking various images of the various items as they are laid out or placed on a known size platform. In one preferred arrangement, a stepper motor system is utilized to generate a plurality of inventory item images.

### Step 735—Operating Stepper Motor to Position Camera

For example, such a stepper motor is a type of electric motor that can rotate in precise and fixed angles, called steps. By controlling the number and the order of the steps, the motor shaft of the stepper motor may be moved or positioned to desired positions and operated at a desired speed. The stepper motor of the presently described AI based inventory control system can be used to operate and maneuver the camera by attaching the camera to the motor shaft or to a platform that is driven by the stepper motor. In this way, the camera angle can be adjusted, and the direction of the camera be varied according to various requirements and in order to generate a volume of images for a desired training dataset.

By using a stepper motor to operate and maneuver a camera, various images of the objects can be captured from different angles, distances, and perspectives. This can help create a more comprehensive and realistic learning dataset for training the CNN based computer vision model. For example, you can place the objects on a table or a shelf and use the stepper motor to move the camera around them. The stepper motor can change the zoom and focus of the camera, or to tilt and rotate the camera. As described herein in detail, tools of the machine learning engine can be used to process the images and then label them automatically or manually.

### Step 750—Generating Plurality of Images

Returning to FIG. 7, the process 700 proceeds to step 750 where the camera will be operated to generate a plurality of images of the item at different angles. In one preferred arrangement, these images or photos are generated automatically by the camera under operation of the system AI graphics integrated circuit. Alternatively, these images or photos may be generated manually by a user operating the camera.

During this image processing step, the systems and methods may also utilize certain data augmentation processes. For example, changing the image background colors is a technique that can be used in the data augmentation step of the CNN training process. Data augmentation is a process of creating new and diverse data from the existing data by applying transformations such as rotation, scaling, cropping, flipping, or adding noise. Data augmentation can increase the size and variety of the dataset and reduce the dependency of the model on specific features or patterns.

Changing the image background colors can be useful for some tasks that require the model to be invariant to the background, such as object detection or face recognition. By changing the background colors, the computer vision model can learn to focus more on the foreground objects or faces and ignore the irrelevant background information. Changing the background colors can also help the computer vision model deal with different lighting conditions or environments that may affect the appearance of the images

Once the various photos of the item are generated at one or more different angles, the method will proceed to an image processing step at step 760 in the process 700.

### Step 760—Convert Images to Greyscale

At step 760, processing software such as an image segmentation algorithm converts each of the plurality of images to grayscale. After this conversion step, the image segmentation algorithm will then import the greyscale images into the CNN based computer vision model.

There are several reasons why these dataset images are converted to grayscale for training the CNN based computer vision model. For example, grayscale images have only one channel, while RGB images have three channels. This means that grayscale images have less data to process and store, which can reduce the computational cost and memory usage of the CNN. It can also make the CNN less prone to overfitting, as it has fewer parameters to learn.

Overfitting is a problem that may occur when the CNN based computer vision model learns too well from the training data and fails to generalize to new and unseen data. This means that the model performs very well on the training data, but poorly on the validation or test data. Overfitting can lead to inaccurate predictions, low performance, and poor robustness of the model.

Greyscaling can also simplify the problem. For example, grayscale images can be seen as a simplified version of RGB images, where the color information is discarded and only the intensity or brightness is preserved. This can make the computer vision model focus on the shape, texture, or edge features of the images, which might be more relevant for some tasks than the color features. For example, if the task is to recognize handwritten digits, the color of the ink is not as important as the shape of the digits.

### Step 750—Segmenting Images

After greyscale conversion to occurs at step 740, the process 700 proceeds to step 750 which involves the step of image segmentation. At this process step, image segmentation divides each of the processed grey scale images into regions or pixels that share some common characteristics, such as color, shape, or texture. CNN image segmentation is a technique that can help with hand tool image identification. Image segmentation is the process of dividing an image into multiple segments, each corresponding to an object or a region of interest. By applying image segmentation, the images of the hand tools can be isolated from the background and other irrelevant parts of the image. This can make it easier to classify, measure, or analyze the hand tools based on their shape, size, color, or other features.

For example, UNet is a type of CNN that was developed for biomedical image segmentation. A CNN is a machine learning model that can learn to extract features from images by applying filters and pooling operations. UNet has a special architecture that consists of two parts: a contracting path and an expansive path. The contracting path is similar to a standard CNN, which down samples the image features and extracts high-level features. The expansive path is the opposite of the contracting path, which up-samples the image features and restores the resolution. The expansive path also concatenates the features from the contracting path, which helps to preserve the spatial information and refine the segmentation.

The processing software that comprises an image segmentation algorithm by UNet means that, in one preferred arrangement, the processing software uses UNet as the main model to perform image segmentation tasks. The processing software can input an image and output a segmented image, where each pixel is assigned a label according to the object or region it belongs to. The software can also adjust certain hyperparameters of the processing software, such as the number of filters, the loss function, or the optimization algorithm, to improve the performance and accuracy of the segmentation.

### Step 780—Orient and Denoise Image

After image segmentation at step 770, the process 700 proceeds to step 780 wherein the AI based inventory control system orients and denoise the images. For example, in one preferred arrangement, orienting the images means to rotate, flip, or crop the images so that the resulting image data set will comprise a consistent orientation or perspective. This can help the computer vision model to learn invariant features that are not affected by the orientation of the image. For example, if it is desired to train the computer vision model to recognize a plurality of hand tools, it can be important to orient the image dataset so that the hand tool images are aligned and centered. This can make the computer vision model focus on certain prevalent hand tool features rather than the background or the angle of the hand tools themselves.

At step 780, the AI based inventory control system may also denoise the image data set. Denoising the plurality of images relates to the removal or reduction of the noise that might be present in the images due to low-quality cameras, poor lighting, or compression artifacts. Noise can degrade the quality and clarity of these images, which can affect the performance and accuracy of the computer vision model. By denoising these images, the contrast and sharpness of these images can be enhanced, which can help the computer vision model to extract more meaningful features from the dataset images.

### Step 790—Cropping the Images

At step 790, the image processing software will then automatically crop the various item images. As those of ordinary skill in the art will recognize, the process of image cropping concerns cutting out parts of the images that are not relevant or useful for the task. For example, if it is desired to train the computer vision model to recognize items such as hand tools, the system may be configured to crop out the background and focus on the hand tool itself. This can help the computer vision model to learn the features and shapes of the hand tools more efficiently and accurately. Cropping images can also reduce the size and complexity of the images, which can make the training process faster and more efficient.

### Step 800—Object Detection

Process moves to step 800 where the computer vision model is used to identify and locate objects in the image dataset that has been preprocessed to improve its quality and consistency. To detect an object in an image, in one preferred arrangement, the computer vision model divides the image into a grid of cells and predicts the bounding boxes, class labels, and confidence scores for each cell. In one preferred arrangement, the bounding box comprises a rectangle that encloses the object, the class label is the name of the object, and the confidence score is the probability that the prediction is correct. The computer vision model can detect multiple objects of different classes in the same image, such as screwdrivers, flashlights, pliers, and other types of hand tools.

### Step 810—Classify Detected Objects

Once the images have been cropped, the method 700 will proceed to step 810 where the system will classify detected objects. This means that the system assigns a category or a label to each object that the computer vision model has detected in the image. For example, if computer vision model has detected a pair of pliers, a hammer, and a screwdriver in the image, the system is going to classify them as “a pair of pliers”, “hammer”, and “screwdriver” respectively. Classification is a common task in machine learning, where we want to predict the class of an input based on some features or patterns.

The presently disclosed systems and methods perform both object detection and image classification tasks. The machine vision model predicts the class label for each bounding box that it generates, along with the confidence score. Therefore, the presently disclosed systems and methods do not need to use a separate model or algorithm to classify the objects that the vision machine model has detected. Rather, the presently disclosed systems and methods can use the class labels or classifications identified via the classifications identified in process step 710 as described herein.

However, in one preferred arrangement, the presently disclosed systems and methods may be operated to perform a more fine-grained or specific classification. For example, if we want to classify the model of the specific tool, or the manufacturer of the specific tool, and therefore the systems and methods might need to use a different model or dataset that has more detailed classes. In that case, the presently disclosed systems and methods may use the bounding boxes from computer vision model as the input for another classifier model and get the more refined class labels from it.

As just one example, the step 820 may comprise the step of labeling each item with a category and/or a part number for each item. In one preferred arrangement, the category and part number definition step may be performed automatically. Alternatively, in another preferred arrangement, the category and/or part number labeling step may be performed or manually. In yet another alternative preferred arrangement, the category and/or part number labeling step may be performed automatically for certain a certain number of the items and manually for certain other of the items.

Step 790 Detect Object Type from Detected Class

It means that we are going to further refine the class label of the object that YOLOv8 has detected by using another model or algorithm. For example, if YOLOv8 has detected a car in the image, we might want to detect the type of the car, such as sedan, SUV, or truck. To do this, we need to use a different model or dataset that has more specific classes for cars.

One possible way to detect the object type from a detected class is to use the bounding box coordinates that are provided by the computer vision engine and crop the image to get the region that contains the object. Then, this cropped image can be processed by another model that is trained to classify the object types.

Another possible way to detect the object type from a detected class is to use the features that the machine vision engine extracts from the image and apply another algorithm to cluster or classify them. For example, in one preferred arrangement, a k-means algorithm may be utilized to group the features into different clusters and assign a label to each cluster based on the object type.

For example, in one preferred arrangement, a k-means algorithm clustering method may be utilized that partitions a set of data points into a predefined number of groups, called clusters, based on their similarity. The algorithm works by randomly initializing a set of cluster centers, and then iteratively assigning each data point to the nearest cluster center and updating the cluster centers based on the average of the assigned data points. The algorithm stops when the cluster assignments do not change or a maximum number of iterations is reached.

For computer vision model hand tool classification, a k-means algorithm can be used to group features into different clusters and assign a label to each cluster based on the object type. For example, suppose the data set of images represent images from different hand tools, such as hammers, screwdrivers, wrenches, etc. Features from each image can be extracted, such as color, shape, texture, or edge, and represent each image as a vector of feature values. Then, the proposed systems and methods can apply a k-means algorithm to cluster the feature vectors into a predefined number of clusters, such as 10, corresponding to the number of hand tool types. Each cluster will contain feature vectors that are similar to each other and dissimilar to those in other clusters. Finally, labels can then be assigned to each cluster based on the majority or the representative object type in the cluster, such as hammer, screwdriver, wrench, etc. This way, the disclosed systems and methods can classify the images of hand tools based on their features and cluster labels.

Alternatively, or in addition to, one arrangement may utilize a support vector machine (SVM) or a decision tree to classify the features into different types. For example, a support vector machine (SVM) comprises a supervised learning algorithm that can classify features into different types by finding an optimal boundary that separates the data points of different classes. A decision tree comprises a supervised learning algorithm that can classify features into different types by creating a tree-like structure of rules based on the values of the features.

For computer vision model hand tool classification, both SVM and decision tree can be used to identify the type of hand tool in an image, such as hammer, screwdriver, wrench, etc. The features can be extracted from the image using various methods, such as color, shape, texture, edge, or histogram of oriented gradients (HOG). The features can then be used as inputs for the SVM or the decision tree to predict the output class.

As just one example, the SVM can use different kernel functions to transform the features into a higher-dimensional space where they can be more easily separated. The SVM can also use regularization parameters to control the trade-off between the margin and the misclassification error. The decision tree can use different splitting criteria to select the best feature and the best threshold to divide the data at each node. The decision tree can also use pruning techniques to avoid overfitting and reduce the complexity of the tree.

Both SVM and decision tree have their advantages and disadvantages for computer vision model hand tool classification. The SVM can handle high-dimensional and non-linear data, but it can be sensitive to the choice of kernel and parameters, and it can be computationally expensive. The decision tree can be easy to interpret and implement, but it can be prone to overfitting and instability, and it can be affected by noise and outliers.

### Step 830 Detect Object Orientation

The process 700 then proceeds to the step 830 of object orientation. At this process step, it means that the disclosed system and methods will estimate the angle or direction of the hand tool in the image based on the key points detected by computer vision model. For example, if the image represents a hammer and its orientation is to be detected, the system might use two key points: the head of the hammer and the handle of the hammer. By calculating the slope or the angle between these two points, the computer vision model can determine the orientation of the hammer in the image.

Object orientation detection can be useful for applications such as robotic manipulation, quality control, or inventory control. For instance, if the system needs to determine if the hand tool has been properly returned to its desired location within an inventory control system (i.e., properly seated within a drawing of a toolbox), the inventory control system will need to know the orientation of the tool within the tool box drawer. Or, if the system wants to check if a hand tool is correctly assembled or aligned, it will need to compare its orientation with a reference value. Or, if the system wants to overlay a virtual hand tool on a real image, we need to match its orientation with the image perspective.

To use computer vision model to detect the object orientation when the object comprises a hand tool, the computer vision model may perform the following steps:

Train the computer vision model key point detection model on a custom dataset that contains images of hand tools with annotated keypoints.

Use the trained computer vision model to detect the keypoints of the hand tool in a new image. The model will output the bounding box coordinates, the class label, and the confidence score for each key point.

Use a mathematical formula or a geometric algorithm to calculate the orientation of the hand tool based on the keypoints. For example, the computer vision model can utilize the arctangent function to find the angle between two points, or the model can use the cross product to find the direction vector of the hand tool.

### Step 830 Detect Broken or Deformed Tools

After step 830, the process 700 proceeds to step 840 where the computer vision system is utilized to detect if the image represents a broken or deformed tool. Here, the computer vision system will identify and locate tools that are damaged or misshapen in an image and compare them with the expected or normal shape of the tools. For example, computer vision model may detect broken or deformed hammers by using the keypoints of the head and the handle of the hammer, and measure the distance, angle, or curvature between them. If the values are significantly different from the normal range, the computer vision model can flag the hammer as broken or deformed.

Broken or deformed tool detection can be useful for applications such as inventory management, quality control, or maintenance. For instance, if we want to keep track of the number and condition of the tools in a warehouse, the computer vision model can scan the images of the various tools in a toolbox, and detect any tools that are missing, broken, or deformed. Or, the computer vison model can check if the tools are safe and functional before using them, wherein the model can be used to inspect the images of the tools and detect any defects or damages that might affect their performance or reliability. Or, if it is desired to repair or replace the tools that are broken or deformed, the model can be used to identify the type and severity of the problem and suggest the appropriate action or solution.

As just one example, to use the computer vision model to detect broken or deformed tools, the following steps may be initiated.

Train a model key point detection model on a custom dataset that contains images of tools with annotated key points and labels. Hand tool key points would be labled and the condition of the tools on the images and generate a dataset for training.

Then, the model would be to detect the keypoints and the labels of the tools in a new image. The model will output the bounding box coordinates, the class label, the condition label, and the confidence score for each tool.

Next, a mathematical formula or a geometric algorithm could be used to calculate the shape, or the deformation of the tool based on the keypoints. For example, the Euclidean distance could be used to measure the length of the tool, or the cosine similarity to measure the angle of the tool.

Compare the calculated values with the normal or expected values for the tool type, and determine if the tool is broken or deformed. For example, a threshold or a range could be used to decide if the value is within the acceptable limit, or a classification or a regression model could be used to predict the probability or the degree of the deformation.

### Step 850 Measure Objects Dimension

The process 700 then proceeds to step 850 where the dimension of the identified object is measured. In a computerized hand tool inventory control system that uses a computer vision model to identify the state and condition of a hand tool, it can important to determine the dimension of the identified object for several reasons.

For example, it will help to ensure the accuracy and consistency of the inventory data, as different types and sizes of hand tools may have different prices, weights, and storage requirements.

It can also help to monitor the wear and tear of the hand tools, as the dimension of the object may change over time due to usage, damage, or corrosion.

It can also help to optimize the space utilization and layout of the inventory, as the dimension of the object may affect the packing and stacking efficiency and the accessibility of the hand tools.

It can also facilitate the quality control and maintenance of the hand tools, as the dimension of the object may indicate the performance and functionality of the hand tools.

To measure the dimension of the object using the presently disclosed computer vision model, the following steps may be required.

First, capture an image of the object using a camera with a known focal length and resolution.

Next, apply the model to detect and segment the object from the background, and obtain its bounding box coordinates and mask.

Then, calculate the pixel resolution, which is the actual length that corresponds to a single pixel of the image, using a reference object with a known dimension in the same image.

Next, convert the pixel values of the bounding box and the mask to real-world units, such as millimeters or centimeters, using the pixel resolution.

And finally, compute the dimension of the object, such as length, width, height, diameter, or area, using the converted values of the bounding box and the mask.

### Step 830 Compile Results Against Database and Update UI

Once the objects dimensions are computed at step 850, the process 700 proceeds to step 860 where the results are compiled against a database and where the user interface is updates. This means that the information that the computer vision model has provided about the tools in the image and compare it with the data that is stored in the inventory database. This way, the inventory records can be updated and the user interface with the latest status and condition of the tools revised (if necessary). For example, the inventory control systems as disclosed and described herein can perform the follow.

Check if the tools that the model has detected match the tools that are expected to have in the present system's inventory. If there are any discrepancies, such as missing, extra, or wrong tools, these can be flagged, and the proper notification can then be generated.

Check if the tools that model has detected are broken or deformed, and if so, how severely. If the tools are beyond repair, these items can marked as unusable and removed from the inventory. If the tools can be fixed, these can be mark as damaged and then sent or processed for proper maintenance or follow-up. The AI based inventory control system can also be updated with the number and type of tools that need to be replaced or repaired.

Can also check if the tools that the model has detected have the correct orientation and position. If the tools are not properly aligned or organized within their expected place within the control system (i.e., properly seated within the toolbox drawer), an alert can be generated and suggest the optimal way to store or display or place the tools. This can help to improve the efficiency and safety of the inventory system.

Updating the user interface with the results of the comparison can serve a number of useful functions. For example, in one arrangement, a graphical or a textual interface to show the user the current inventory status, the detected tools, and the actions that need to be taken. The AI based inventory control system can included, change or modify color codes, icons, or charts to highlight the important or urgent hand tool information. The control system can also provide the user with the option to confirm, edit, or cancel the changes that the system proposes.

To compile the results against the existing inventory hand tool database and update the user interface, the AI based inventory control system may perform the following steps.

Connect the model output with the inventory database. In one preferred arrangement, the programming language or a framework that supports both image processing and database operations, such as Python, Java, or C#can be utilized. An API or a middleware to communicate between the model and the database may also be utilized.

Query the inventory database to get the data that is needed to compare with the model output. SQL or a query language can be utilized to select the relevant columns and rows from the database tables, such as the tool ID, name, type, condition, and/or location.

Compare the model output with the inventory database data. For example, a logical or a mathematical algorithm to check for any differences or similarities between the two data sources and generate a list of changes or actions that need to be made.

Update the inventory database with the changes or actions by using SQL or a query language to insert, update, or delete the data in the database tables, according to the results of the comparison.

Then, the system can update the user interface with the changes or actions. In one preferred arrangement, a graphical or a textual interface can be utilized to display the data and the results to the user, using elements such as labels, buttons, text boxes, and images. In one arrangement, a web or a mobile platform can be utilized to make the user interface accessible and interactive.

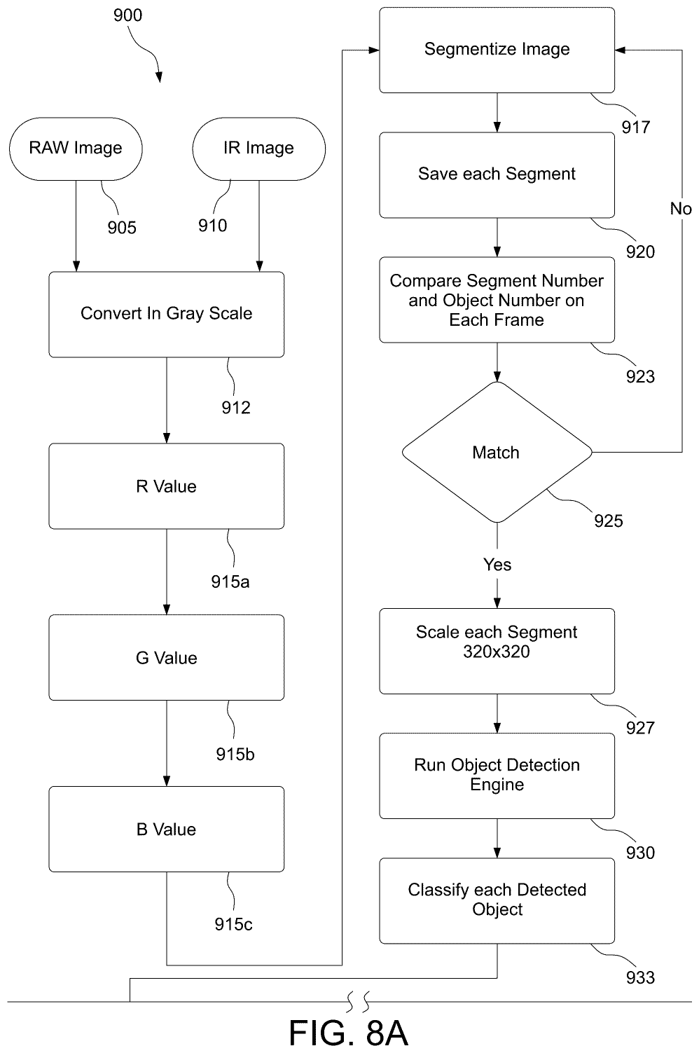

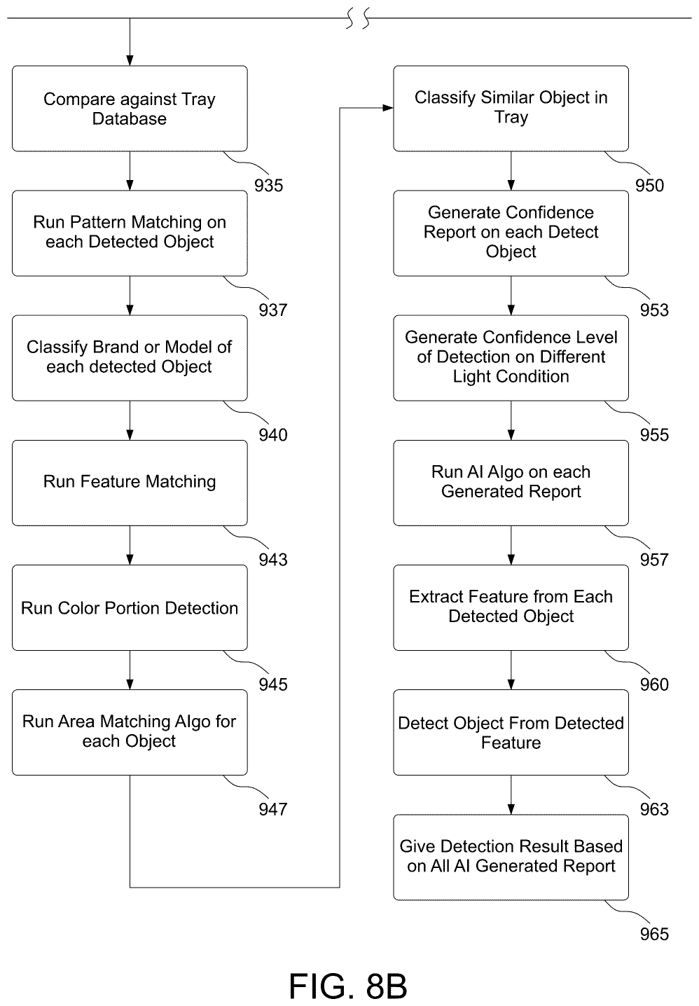

FIG. 8 illustrates another exemplary method 900 of training a CNN for use with an AI based inventory control system, such as the AI based inventory control system illustrated in FIG. 5.

### RAW Image and IR Image.

In one preferred arrangement, the image processing software receives different types of images. As just one example, in a preferred arrangement, the image processing software may receive RAW Image(s) 905 and an IR Image(s) 910. There are several reasons why, in one preferred software arrangement, both a RAW image and an infrared (IR) image would be utilized for an AI-based image recognition engine. For example, in one arrangement, these images may provide complementary information. As just one example, RAW images capture the unprocessed data from the camera sensor. This provides the most detail and flexibility for the AI engine to analyze things like color, texture, and fine details.

IR images capture heat signatures, which can be useful in situations where the visible spectrum is limited. For instance, IR can see through fog or darkness, and can be helpful in identifying objects that have different temperatures than their surroundings. By combining the information from both types of images, the image processing software can get a more complete picture of the scene and improve its recognition accuracy.

In addition, combining such images may also provide more robustness to certain challenges. For example, regular cameras can struggle with variations in lighting, shadows, or occlusions (like something blocking the view). IR has certain advantages. For example, IR imaging can bypass some of these challenges. It can be used for facial recognition even in low light or with sunglasses on a person's face. Including both RAW and IR data gives the image processing software a better chance of successfully recognizing objects regardless of the lighting conditions or other factors that might affect a regular image.

### Convert in Grey Scale

At step 912, processing software such as an image segmentation algorithm converts each of the plurality of RAW and IR images to grayscale. After this conversion step, the image segmentation algorithm will then import the greyscale images into the CNN based computer vision model.

There are several reasons why these dataset images are converted to grayscale for training the CNN based computer vision model. For example, grayscale images have only one channel, while RGB images have three channels. This means that grayscale images have less data to process and store, which can reduce the computational cost and memory usage of the CNN. It can also make the CNN less prone to overfitting, as it has fewer parameters to learn.

Overfitting is a problem that may occur when the CNN based computer vision model learns too well from the training data and fails to generalize to new and unseen data. This means that the model performs very well on the training data, but poorly on the validation or test data. Overfitting can lead to inaccurate predictions, low performance, and poor robustness of the model.

Greyscaling can also simplify the problem. For example, grayscale images can be seen as a simplified version of RGB images, where the color information is discarded and only the intensity or brightness is preserved. This can make the computer vision model focus on the shape, texture, or edge features of the images, which might be more relevant for some tasks than the color features. For example, if the task is to recognize handwritten digits, the color of the ink is not as important as the shape of the digits.

### R Value, G Value, and B Value

Returning to the method 900 illustrated in FIG. 8, the process proceeds to the steps 915 a, b, c of extracting R (Red), G (Green), and B (Blue) values. Extracting the R (Red), G (Green), and B (Blue) values and converting an image to grayscale for an AI-based image detection model can have several benefits.

For example, grayscale images reduce the complexity of the data. Instead of dealing with three color channels (R, G, B), the model only needs to process a single channel. This simplification can make the model faster and easier to train.

Grayscale images emphasize intensity information without color, which can sometimes be more relevant for certain detection tasks. For instance, edge detection, shape recognition, and texture analysis often rely more on intensity contrasts than color information.

Using grayscale images reduces the memory footprint and computational requirements. Since grayscale images have only one channel, they require less storage space and less processing power compared to RGB images.

Grayscale conversion can also help in improving the generalization of the model. Color can sometimes introduce variations that are irrelevant to the task at hand. By converting to grayscale, the model might become more robust to changes in lighting conditions, color variations, and other non-essential differences. Some models and algorithms were originally developed for grayscale images. Converting to grayscale can make it easier to apply these established techniques and leverage existing research.

Color information can sometimes introduce noise or irrelevant features that might confuse the model. Grayscale conversion can help in reducing this noise by focusing on the luminance channel.

In some cases, ensuring consistent preprocessing across different datasets and sources may be crucial. Converting to grayscale can standardize the input format, thereby helping to ensure that the model processes images uniformly. Overall, converting images to grayscale can streamline the training process, reduce computational demands, and sometimes even improve the performance of the AI-based image detection model, depending on the specific application and the nature of the images involved.

Converting images to grayscale while also keeping the original RGB values can provide certain advantages in an AI-based image processing system. This dual approach leverages the strengths of both grayscale and color information, which can be beneficial for various tasks. For example, grayscale images can highlight intensity-based features such as edges, gradients, and textures more clearly. These features are useful for tasks like edge detection, shape recognition, and texture analysis.

RGB values provide color information, which can be crucial for certain image recognition tasks like object classification, scene segmentation, and detecting objects where color is a key differentiator. In addition, redundancy in features can also make the system more robust. If one type of feature (color or grayscale) is not reliable under certain conditions (e.g., poor lighting), the other can compensate.

Grayscale and RGB features can complement each other. Some patterns may be more easily detectable in grayscale, while others require color differentiation. Moreover, combining grayscale and RGB features can enhance the input to the neural network, potentially leading to better performance. For instance, feeding both grayscale and RGB channels into a CNN can provide more comprehensive information for the model to learn from.

The system can also be more flexible in adapting to different tasks or environments. For example, a task that primarily relies on texture can use grayscale features, while another that depends on color can use RGB features. Such a combined system can also help to ensure proper preprocessing of both grayscale and RGB images to maintain consistency in scale, normalization, and format.

In such a combined approach, the model architecture may need to be adapted to handle multi-channel inputs. For instance, in one arrangement, the neural network can have separate branches for grayscale and RGB processing that merge later in the network. Storing and processing both grayscale and RGB images can increase computational and storage requirements. In certain arrangements, the trade-off between increased resource usage and potential performance gains should be evaluated.

Consider an object detection task where color and texture are both important. By providing both grayscale and RGB images to the model, the model can learn to recognize objects based on texture patterns visible in the grayscale images and color cues from the RGB images. This could be particularly useful in scenarios where objects have distinct color patterns or where lighting conditions vary.

In one preferred combined approach, incorporating both grayscale and RGB features in an AI-based image processing system can offer significant advantages by leveraging the strengths of each type of information. While this approach introduces some complexity, the potential improvements in robustness, feature diversity, and model performance can justify the additional effort, especially for tasks that benefit from both color and intensity-based features.

### Segment Image

Returning to the process 900 illustrated in FIG. 8, the process 900 proceeds to step 917 which concerns segmenting an image after converting it to grayscale and extracting the R, G, and B values. Such a segmentation process step 917 can be beneficial for several reasons in an AI-based image detection model.

As just one example, image segmentation can help in isolating regions of interest within the image. By focusing on specific segments, the model can effectively extract relevant features from each segment, leading to better performance in tasks such as object detection, classification, and recognition. Segmentation can also help in filtering out irrelevant or noisy parts of the image, allowing the model to focus only on the meaningful regions. This can enhance the overall accuracy and robustness of the model.

In certain cases, the objects of interest are located within specific regions of the image. Segmenting the image allows the model to identify and analyze these regions more precisely, improving its ability to detect and recognize objects. Also, by segmenting the image, the model can process smaller, more manageable portions of the image sequentially or in parallel. This can lead to faster processing times and reduced computational load, especially when dealing with large or high-resolution images.

Complex scenes with multiple objects and varying backgrounds can be challenging for detection models. Segmentation can simplify these scenes by breaking them down into smaller, more homogeneous regions, making it easier for the model to handle and interpret certain images. Furthermore, segmentation can guide the model's attention to specific parts of the image, ensuring that the model focuses on the most relevant areas. This can be particularly useful in scenarios where the objects of interest are small or located in cluttered environments. Segmenting the images can also improve the quality of the training data by providing more accurate and detailed labels for the different regions of the image. This can lead to better training outcomes and more effective learning by the model.

Overall, segmenting a grayscale image after extracting the R, G, and B values can help in isolating important regions, reducing noise, and improve the efficiency and accuracy of the AI-based image detection model.

### Save Each Segment

Returning to the process 900 illustrated in FIG. 8, the process 900 proceeds to step 920 where each segment of the images is saved. Saving each segment of the image after segmentation in an AI-based image recognition software can be important for several reasons. In a preferred arrangement, image segmentation involves dividing an image into meaningful regions or segments, which may results in the enhancement of the analysis and recognition processes.

By isolating segments, the system can focus on specific parts of the image, allowing for a more detailed analysis of each segment's features (shape, texture, color, etc.). Segmentation reduces the complexity of the image by focusing on relevant parts, reducing the impact of background noise and irrelevant information. Segmented images allow for object-specific feature extraction and classification. Each segment can be analyzed independently, improving the accuracy of object detection and recognition tasks.

Saving segments provides valuable data for training machine learning models. Models can be trained on individual segments, enhancing their ability to recognize and classify different objects or regions. In addition, stored segments can be used for data augmentation, creating more training examples by manipulating individual segments (e.g., rotation, scaling, flipping).

Saved segments can undergo additional post-processing steps, such as further segmentation, filtering, or enhancement, to improve recognition performance. Segmentation allows for targeted error correction. If a segment is misclassified or poorly processed, it can be individually corrected without affecting the rest of the image.

In addition, saving segments enables multi-stage processing pipelines, where initial segmentation is followed by more sophisticated analyses. For example, in one arrangement, a coarse segmentation might be followed by fine-grained object detection within each segment. Segmented parts can be integrated with other data sources or analytical processes, allowing for comprehensive multi-modal analysis. And in certain arrangements, individual segments can be processed in parallel, optimizing computational resources and speeding up the recognition process.

Furthermore, resources can be allocated more efficiently by focusing processing power on relevant segments rather than the entire image. Keeping segmented parts also allows for better traceability and debugging. Analysts can revisit specific segments to understand errors or improve model performance. Saving segments also helps in documenting the analysis process, making it easier to review and share findings.

Saving each segment of an image after segmentation in an AI-based image recognition system can be essential for enhancing accuracy, enabling detailed analysis, facilitating model training, optimizing resources, and ensuring traceability. This approach supports a more robust and efficient image recognition process by allowing the system to handle complex images in a structured and manageable way.

### Compare Segment Number and Object Number on Each Frame

Returning to the process 900 illustrated in FIG. 8, the process 900 proceeds to step 923 where the image processing software compares segment numbers and object numbers. In one preferred image processing software arrangement, the image processing software compares segment numbers and object numbers on each frame. However, as those of ordinary skill in the art will recognize, alternative comparative steps and processes may be utilized as well.

In the context of an AI-based image detection model, comparing the segment number and object number on each frame means evaluating the consistency and accuracy of the segmentation process and object detection within each frame of a video or sequence of images. As just one example, such a process may refer to the number of distinct segments identified in each frame after the image segmentation process. For example, each segment may represent a contiguous region of pixels that the algorithm has grouped together based on some criteria, such as color, texture, intensity, or other similar or like characteristic.

In one arrangement, the object number refers to the number of distinct objects that the object detection algorithm identifies within each frame. An object could be anything of interest defined by the model, such as people, cars, animals, or other relevant entities.

There are multiple reasons for comparing the segment number and object numbers. For example, by comparing the number of segments with the number of detected objects, the system can assess whether the segmentation process is effectively isolating meaningful regions corresponding to actual objects. If the segment number is significantly higher than the object number, it might indicate over-segmentation. That is, where objects are split into too many segments. Conversely, if the segment number is lower, it might indicate under-segmentation. In other words, under-segmentation may occur where multiple objects or object parts are grouped into a single segment.

This comparison can also act as a consistency check. Consistent segment and object numbers across frames may suggest that the model is stable and reliable in its segmentation and detection processes. Inconsistencies might indicate issues with the segmentation algorithm or the detection model, requiring further tuning or improvements.

Such a comparison may also provide a certain degree of detection accuracy. Comparing segment and object numbers helps in evaluating the accuracy of the object detection model. Ideally, there should be a close correspondence between segments and detected objects if the segmentation is correctly isolating each object. Discrepancies might point to false positives or false negatives in object detection.

In addition, this comparison can be used to derive performance metrics such as precision, recall, and F1-score for both segmentation and detection tasks. For instance, the system can calculate the ratio of correctly identified segments to the total number of segments to measure segmentation accuracy.

Moreover, identifying mismatches between segments and objects can help in error analysis. For instance, if certain objects are consistently missed or wrongly segmented, it can provide insights into specific challenges or limitations of the current model, guiding further refinement.

In one arrangement, such a comparison might comprise a frame-by-frame analysis. That is, for each frame in the sequence, the software may count the number of segments and the number of detected objects. Then, the system can overlay the detected objects on the segmented image to visually inspect if each segment corresponds to an actual object and vice versa. Next, the system can perform a statistical comparison by aggregating the segment and object counts across all frames and use statistical measures to evaluate performance and consistency.

Based on the comparison results, the system can adjust the segmentation and object detection algorithms to improve alignment between segments and objects. By systematically comparing the segment number and object number on each frame, the model can operate to help ensure that the AI-based image detection model is performing optimally, with accurate segmentation and reliable object detection.

### Match

At the next step in the process 900 illustrated in FIG. 8, the software will perform a matching step. If a match is determined to exist, the process will continue to the next step in the process which is a scaling step 927. If no match is determined as step 925, the process 900 returns to step 917 to repeat the step of image segmentation.

### Scale Each Segment

At step 927 in the process, the image detection software performs a scaling step. In one arrangement, the step 927 performs a 320×320 scaling step although those of ordinary skill in the art will recognize, alternative scaling measures may also be utilized. In the context of an AI-based image detection model, scaling each segment to 320×320 refers to resizing each segmented region of an image to a fixed dimension of 320 pixels by 320 pixels. This process can be performed for a number of reasons.

For example, certain AI models, especially convolutional neural networks (CNNs), require inputs of a consistent size. By scaling each segment to 320×320, the present image detection software helps to ensure that segments have the same dimensions, which tends to simplify the processing and avoids issues that might arise from varying input sizes.

In addition, pre-trained models or specific architectures might be designed to work with inputs of a particular size. For instance, a model pre-trained on 320×320 images will expect inputs of that size. Scaling segments to 320×320 makes them compatible with such models.

Resizing segments to a uniform size also allows the model to extract features consistently across all segments. This consistency can improve the performance of the model as it can ensure that the scale of features remains the same, making it easier for the model to learn and recognize patterns.

Moreover, fixed-size inputs can be processed more efficiently in batches, as the computational resources (such as memory and processing power) can be allocated more effectively. This can lead to faster training and inference times.

Scaling all segments to the same size can also help in normalizing the data, which can improve the convergence of the training process. It also can help to ensure that segments are treated equally by the model, without bias towards larger or smaller segments.

In one arrangement, the software performs this scaling function in the following manner. First, it performs image segmentation to divide the image into distinct regions or segments based on certain criteria (e.g., color, texture, intensity). For segmented regions, resize the segment to a fixed size of 320×320 pixels. In one preferred arrangement, this is performed using image processing techniques such as interpolation (bilinear, bicubic, etc.).

If a segment cannot be scaled directly to 320×320 while maintaining its aspect ratio, padding might be added to fill the extra space. Padding helps to ensure that the resized segment fits the required dimensions without distortion. In an alternative arrangement, the pixel values (e.g., scaling to a range of [0, 1] or [−1, 1]) are normalized to prepare the segments for input into the model. The resized segments can then entered into the AI model for detection, classification, or other tasks.

There are a number of benefits to scaling step 927. For example, it helps to ensure consistent input size, which can lead to better model performance and accuracy. It can also simplify the training and inference processes by standardizing input dimensions. In addition, it aligns with the input requirements of pre-trained models or specific neural network architectures. It can also enhance computational and memory efficiency by enabling batch processing of uniform-sized inputs.

Overall, scaling each segment to 320×320 can be an important preprocessing step in many AI-based image detection pipelines, helping to ensure that the input data is standardized and optimized for the model's requirements.

### Run Object Detection Engine

After the process completes the scaling step at step 927, the process continues to step 930 which involves running an object detection engine. This step involves using the the model to identify and locate objects in the image dataset that has been preprocessed to improve its quality and consistency. To detect an object in an image, in one preferred arrangement, the computer vision model divides the image into a grid of cells and predicts the bounding boxes, class labels, and confidence scores for each cell. In one preferred arrangement, the bounding box comprises a rectangle that encloses the object, the class label is the name of the object, and the confidence score is the probability that the prediction is correct. The computer vision model can detect multiple objects of different classes in the same image, such as screwdrivers, flashlights, pliers, and other types of hand tools.

### Classify Each Detected Object

Once the object detection engine has been implemented at step 930, the method 900 proceeds to step 933 where the system will classify detected objects. This means that the system assigns a category or a label to each object that the computer vision model has detected in the image. For example, if the computer vision model has detected a pair of pliers, a hammer, and a screwdriver in the image, the system is going to classify them as “a pair of pliers”, “hammer”, and “screwdriver” respectively. Classification is a common task in machine learning, where the system predicts the class of an input based on some features or patterns.

In one preferred arrangement, the presently disclosed systems and methods perform both object detection and image classification tasks. The machine vision model predicts the class label for each bounding box that it generates, along with the confidence score. Therefore, in one arrangement, the presently disclosed systems and methods do not need to use a separate model or algorithm to classify the objects that model has detected. Rather, the presently disclosed systems and methods can use the class labels or classifications identified via the classifications identified in process step 933 as described herein.

However, in one preferred arrangement, the presently disclosed systems and methods may be operated to perform a more fine-grained or specific classification. For example, if the system is called upon to classify the model of the specific tool, or the manufacturer of the specific tool, the systems and methods might need to use a different model or dataset that has more detailed classes. In that case, the presently disclosed systems and methods may use the bounding boxes from the model as the input for another classifier model and get the more refined class labels from it.

As just one example, the step 933 may comprise the step of labeling each item with a category and/or a part number for each item. In one preferred arrangement, the category and part number definition step may be performed automatically. Alternatively, in another preferred arrangement, the category and/or part number labeling step may be performed manually. In yet another alternative preferred arrangement, the category and/or part number labeling step may be performed automatically for a certain number of the items and manually for certain other of the items. However, as those of ordinary skill in the art will recognize, alternative category and part number definition processes may be utilized as well.

### Compare Against Tray Database

After completing step 933, the process 900 illustrated in FIG. 8 proceeds to a comparing step 935. At this process step, the system compares detected and classified objects against a database of known objects in an AI-based image detection model. This process step 935 serves several important purposes.

For example, this process step of matching detected and classified objects to known objects helps validate the accuracy of the model. This comparison can help identify false positives (i.e., incorrectly detected objects) and false negatives (i.e., missed detections), allowing for further refinement and improvement of the model. In addition, by cross-referencing with a database of known objects, the model can improve its classification accuracy. If the model's initial classification is uncertain, the database can provide additional context and information to make a more accurate prediction.

A database of known objects can provide additional attributes and metadata about each object, such as its typical size, shape, color, and usage. This information can enhance the model's understanding and provide richer insights into the detected objects. Comparing detected objects against a database can also help to identify anomalies or unknown objects that do not match entries in the database. This can be particularly useful in security, quality control, and other applications where detecting unusual or unauthorized objects is important.

In applications such as surveillance or inventory management, comparing detected objects against a database allows for tracking and monitoring known objects over time. This can help in identifying movements, changes, or patterns related to specific objects. Many practical applications require integration with other systems that rely on databases of known objects. For instance, in an e-commerce setting, detected products need to be matched with inventory databases to provide accurate information to customers and manage stock levels.

Ensuring that detected objects align with a standardized database helps maintain consistency across different instances of the model and different datasets. This standardization can play an important role for large-scale deployments where uniformity and reliability are important. Discrepancies between detected objects and the database can provide valuable feedback for retraining and improving the model. By analyzing cases where the model's predictions differ from the database, developers can identify areas for enhancement.

In one arrangement, the software performs this comparison step in the following manner. First, it will run the object detection engine to identify and classify objects within the images or video frames. Then, for detected and classified objects, the model will query the database of known objects to find matching entries based on attributes such as shape, size, color, and other features.

It can then define criteria for matching detected objects with database entries. This could involve similarity thresholds, feature matching, or other comparison techniques. The model can then validate the detected objects against the database entries while also confirming matches and flag discrepancies for further analysis. Based on the comparison, the model can take appropriate actions such as flagging anomalies, updating object information, or integrating with other systems. The model can then use the results of the comparison to provide feedback for retraining the model, improving its accuracy and robustness. By systematically comparing detected objects against a database of known objects, an AI-based image detection model can achieve accuracy, reliability, and contextual understanding, making it more effective for various real-world applications.

### Run Pattern Matching On Detected Objects

At the next step in the process 900 illustrated in FIG. 8, the process 900 will complete step 937 where the software will run pattern matching on detected objects. In a preferred arrangement, the software will run pattern matching on each detected object. Running pattern matching on each detected object after classifying and comparing them against a database of known objects in an AI-based image detection model can serve several important purposes.

For example, pattern matching can help verify the initial classification by providing an additional layer of validation. This can improve the overall accuracy of the detection and classification process. It ensures that the detected objects not only match the known objects based on high-level attributes but also exhibit the specific patterns or features expected of those objects. This can be particularly useful in distinguishing between similar objects with subtle differences. Pattern matching can also help identify variations or defects in objects that might not be apparent through basic classification. For example, in quality control, it can detect defects or anomalies in manufactured products.

In addition, such a pattern matching step can also improve the model's robustness to noise and variations in the input images by focusing on the consistent patterns that define each object. This can be quite useful in real-world scenarios where images may be noisy or have varying lighting conditions. Patterns often provide contextual information that can enhance the understanding of the scene. For instance, recognizing the pattern on a piece of clothing can provide additional context about the detected person. Pattern matching can enhance the efficiency of searching and retrieving objects from large databases by focusing on unique patterns that define each object, making the process faster and more accurate.

In one preferred arrangement, the presently disclosed systems and methods perform the following pattern matching processing step in the following manner. First, the model identifies and extracts distinctive patterns or features from each detected object. This could involve texture patterns, shapes, edges, or other relevant features. The model then compares the extracted patterns against the patterns stored in the database of known objects. This comparison can be done using various techniques such as template matching, feature matching, or more advanced algorithms like SIFT (Scale-Invariant Feature Transform) or SURF (Speeded-Up Robust Features).

Next, the model measures the similarity between the detected patterns and the database patterns using similarity metrics like Euclidean distance, cosine similarity, or more sophisticated methods. The model can then validate the detected objects based on the pattern matching results while also confirming the matches and identify any discrepancies or anomalies. The model can then use the pattern matching results to provide feedback for refining the object detection and classification algorithms. This feedback can help improve the model's accuracy and robustness over time. By incorporating pattern matching into the detection and classification process, the AI model can achieve a higher level of precision and reliability, making it more effective for various applications such as quality control, surveillance, and object recognition.

### Classify Brand or Model of Each Detected Object

The process 900 illustrated in FIG. 8 proceeds to step 940 which involves classifying the brand or model of detected objects. Classifying the brand, model, or manufacturer of each detected object after running an object detection engine, classifying detected objects, comparing them against a database of known objects, and running pattern matching has several important purposes, some of which are explained below.

For example, knowing the specific brand, model, or manufacturer adds a layer of detail to the object recognition process. This granularity can be crucial for applications that require precise identification of objects, such as inventory management, retail, and product authentication. In addition, in consumer applications, such as augmented reality shopping or automated customer support, being able to identify the exact brand and model can provide a more personalized and relevant user experience. And in retail and marketing, understanding which brands and models are present in an environment can help analyze market trends, consumer preferences, and competitive positioning.

Moreover, in manufacturing and quality control, identifying the brand and model can help to ensure that each product meets specific standards and specifications. This can help in maintaining quality assurance and detecting counterfeit products. Classifying objects by brand and model can also enhance search and retrieval capabilities in large databases, enabling more efficient and accurate results when looking for specific items. Knowing the brand and model can also provide additional context about the object's features, capabilities, and expected behavior. This information can be useful in various applications, such as surveillance, where recognizing a specific model of a car or device can aid in investigations.

Certain systems, such as inventory management, asset tracking, and customer relationship management (CRM), rely on detailed information about objects, including their brand and model. Classifying objects by these attributes facilitates integration with these systems. And in scenarios where authenticity may play a crucial role, such as luxury goods, electronics, or pharmaceuticals, identifying the brand and model can help detect counterfeit or unauthorized products.

In one preferred arrangement, the presently disclosed systems and methods may perform this identification step in the following manner. First, extract features from the detected object that are relevant for identifying the brand or model. This might include logos, specific design elements, or other distinguishing characteristics. Then, compare the extracted features against a database of known brands and models. This database should contain detailed information about various brands and models, including images and descriptions.

Next, the model may use pattern matching techniques to match the extracted features with those in the database. This can involve more detailed comparisons to ensure accuracy. The model may also use a classification algorithm trained specifically to recognize different brands and models based on the extracted features and patterns. The model can then validate the classification results by cross-referencing with multiple data sources and checking for consistency. The model can then also use the results to provide feedback for improving the feature extraction and classification algorithms, enhancing their accuracy over time.

By classifying the brand, model, or manufacturer of each detected object, the AI-based image detection model can achieve a higher level of specificity and usefulness, making it more effective for applications that require detailed and accurate object identification.

### Run Feature Matching Step 943

Process 900 continues to the next step 943 where the software system runs a feature matching process step. Running feature matching after the steps of object detection, classification, database comparison, pattern matching, and brand or model classification involves comparing detailed features of each detected object to those of known objects. This process provides several benefits and serves purposes in enhancing the accuracy and reliability of the image detection model.

The benefits and purposes of this running feature matching step 943 are several. For example, feature matching helps verify the initial classification results by comparing detailed features of the detected objects with those in the database. This helps to ensure that the classification (e.g., brand, model, manufacturer) is accurate and not just a rough match. Detailed feature matching can also differentiate between very similar objects that may have been classified under the same category initially. It helps to ensure that even subtle differences are recognized, which is important for applications requiring high precision.

In addition, feature matching can identify and correct errors in earlier stages of the detection process. If an object was misclassified due to similarities with other objects, feature matching can provide a more accurate identification. By using feature matching, the model becomes more robust to variations in lighting, angle, scale, and other environmental factors. This helps to ensure consistent and reliable performance across different conditions.

In complex scenarios with overlapping or occluded objects, feature matching can help in distinguishing and correctly identifying objects by focusing on their unique features. Feature matching can be crucial in security applications, such as facial recognition or identifying counterfeit products. It helps ensure that the detected objects are genuine and match the known features of authorized objects.

In one preferred arrangement, this feature matching process step 943 involves extracting detailed features from the detected object. These features could include edges, key points, textures, shapes, and specific patterns that are unique to the object. In addition, descriptors for the extracted features are calculated. Descriptors comprise numerical values that represent the unique characteristics of the features. Common methods include SIFT (Scale-Invariant Feature Transform), SURF (Speeded-Up Robust Features), ORB (Oriented FAST and Rotated BRIEF), and others.

This process step 943 compares the extracted features and their descriptors with those in the database of known objects. In one arrangement, the database contains pre-computed descriptors for accurate and efficient matching. The process step then measures the similarity between the detected object's features and the database features using techniques like Euclidean distance, cosine similarity, or more advanced matching algorithms. Based on these similarity measurements, the process step 943 determines if the detected object matches any of the known objects in the database. In one preferred arrangement, a threshold is set for similarity to decide matches. This process step can then validate the matches by cross-referencing with multiple features and ensuring consistency across different parts of the object.

Other process steps may also be incorporated. For example, key point detection may be incorporated. This is where the software identifies keypoints in the detected object image that are distinctive and invariant to scale and rotation. In addition, the software may wse algorithms like FLANN (Fast Library for Approximate Nearest Neighbors) or BFMatcher (Brute-Force Matcher) to match descriptors between the detected object and database entries. RANSAC (Random Sample Consensus) may also be applied so as to remove outliers and improve the robustness of the matching process. The software may also aggregate the matching results to make a final decision about the object's identity and classification.

By incorporating feature matching into the detection pipeline, the AI-based image detection model helps to ensure a higher level of accuracy and reliability, making it suitable for applications where precise identification and classification of objects may be crucial.

### Run Color Portion Detection

At the next step in the process 900 illustrated in FIG. 8, the process 900 proceeds to the step 945 related to the model running color portion detection. Running color portion detection step 945 after the previous steps (object detection, classification, database comparison, pattern matching, brand/model classification, and feature matching) can add another layer of verification and context to the image detection model.

There are a number of reasons why the model may run such a color portion detection step, such as helping to enhance accuracy and verification. For example, even after detailed feature matching, color can provide additional confirmation that the object is correctly identified. Specific brands, models, or objects might have characteristic colors, trademarks, trade dress, corporate/company logos, or color patterns that can further validate the detection.

In addition, objects that are similar in shape and features but differ in color can be accurately distinguished using color portion detection. This can be crucial in applications like retail or quality control where precise identification is required. Moreover, color information can provide additional context about the detected objects. For example, the color of a car or a piece of clothing can be important for inventory management, fashion recommendations, or surveillance.

In certain applications, such as medical imaging or industrial inspection, specific colors or color changes can be indicative of particular conditions or defects. Color portion detection can highlight these nuances. Certain objects may have color-based features that are critical for their identification. For example, logos, brand markings, or specific design elements often use unique color schemes that can be detected.

The color portion detection step 945 may be accomplished based on the following process steps. For example, the software may identify and extract the color features of the detected object. This involves analyzing the image to determine the color distribution, dominant colors, and color patterns. The software can then convert the image into a suitable color model (e.g., RGB, HSV, Lab) that makes it easier to analyze the color properties. Different color models can provide different insights; for instance, HSV (Hue, Saturation, Value) can separate color information from intensity.

The software may then segment the image based on color. In one preferred arrangement, this may involve identifying regions of the image that share similar color properties. In one preferred arrangement, techniques like k-means clustering or histogram-based segmentation can be used. The software can then analyze the segmented color portions to identify patterns that are characteristic of specific objects. This could involve recognizing color stripes, gradients, or patches.

The process may then compare the extracted color features and patterns against a database of known objects, which includes their color information. This can help in validating the object's identity. Next, the preferred system may then measure the similarity between the detected object's color properties and the database entries. Metrics like color histograms, color moments, or more advanced color similarity measures can be used.

In one preferred preprocessing step, the system will normalize the image to account for lighting variations. This might include techniques like white balancing or color constancy algorithms. The system will then convert the image from RGB to other color spaces like HSV or Lab for better analysis of color properties. Then, the system will calculate color histograms to represent the distribution of colors within the object. This can provide a compact representation of the color information. The system may then rely on using clustering algorithms (e.g., k-means) to segment the image based on color. This helps in isolating different color regions within the object. Next, the system identifies and analyzes specific color patterns that are characteristic of the object. This could involve recognizing logos, brand colors, or specific design elements. Then, the system will compare the detected color portions with the database entries. The system can then validate the matches and ensure consistency with the known characteristics of the object.

By incorporating color portion detection into the detection pipeline, the AI-based image detection model can achieve a high level of detail and accuracy, ensuring that objects are identified and verified with a comprehensive understanding of their visual characteristics.

### Run Area Matching Algorithm for Each Object

Process 900 continues to the next step 947 which involves running an area matching algorithm for each object. Running an area matching algorithm after all the preceding steps (object detection, classification, database comparison, pattern matching, brand/model classification, feature matching, and color portion detection) serves to verify the size and shape consistency of the detected objects. This process step 947 helps to ensure the detected object's dimensions match those ofthe known objects in the database.

After identifying and classifying an object, verifying its size helps to ensure that it matches the expected dimensions. This is particularly important in quality control, manufacturing, and inventory management where size accuracy is critical. Beyond mere classification, ensuring the object's shape matches the known object helps in distinguishing between objects that are similar in appearance but different in form. In addition, area matching can help identify anomalies or defects in objects. For example, a product that is supposed to have a uniform shape and size may have manufacturing defects that alter its dimensions.

Moreover, combining size and shape information with color, features, and patterns can lead to a more comprehensive and accurate object identification process. This multi-faceted approach serves to reduce the likelihood of misclassification. And in certain applications, such as medical imaging or surveillance, the size and area of detected objects can provide important contextual information. For example, identifying the correct size of a tumor or vehicle is crucial for accurate analysis.

In one preferred arrangement, that process performs the area matching by calculating the area of the detected object. For example, this may involve determining the number of pixels that constitute the object in the image and converting this to real-world dimensions if necessary. The software may then analyze the shape of the detected object. This involves examining the object's boundaries, contours, and overall geometry. The software will then compare the calculated area and shape features with those of known objects in the database. This database should include detailed size and shape information for accurate matching. The software will then measure the similarity between the detected object's area and shape and those in the database. Techniques like contour matching, shape context, or other geometric similarity measures can be used.

In one preferred arrangement, the software will perform the following area matching process steps. For example, the software will first segment the detected object from the background to isolate its shape and size. It will then use edge detection algorithms (like Canny or Sobel) to identify the boundaries of the object. Contours of the object can then be extracted so as to analyze its shape. This involves using algorithms that can identify and analyze the object's outline.

The software will then calculate the area of the object by counting the number of pixels within the detected boundaries. For real-world applications, this may involve scaling factors to convert pixel count to physical dimensions. The software will then compare the object's shape with known shapes in the database. Techniques like Hu Moments, Fourier descriptors, or shape context can be used for this purpose. The detected object's area can then be validated and shaped against the expected values in the database and thereby confirm matches and identify any discrepancies. Such process steps can be important for certain inventory management systems which may require verifying the size of products to ensure proper categorization and storage. By incorporating area matching into the detection pipeline, the AI-based image detection model ensures a higher level of precision and reliability, making it suitable for applications where exact size and shape may be crucial for accurate identification and analysis.

### Classify Similar Object In Tray

The process 900 proceeds to the next step 950 which involves classifying similar known objects. In one preferred arrangement, such similar known object might be contained within a system inventory tray, such as the container trays illustrated in FIGS. 1-4. After the previous steps (object detection, classification, brand/model recognition, feature matching, color analysis, and area matching), there might present a situation wherein the system might still have some ambiguity, especially if there are similar objects in the image.

In a preferred arrangement, the “known tray” refers to a pre-defined set of objects or a database of similar objects. This tray acts as a reference point to further refine the classification of the detected objects. In one preferred arrangement, the system compares the features extracted from the detected object (size, shape, color distribution, etc.) with the objects in the known tray, such as the hand tools contained within the various trays illustrated in FIGS. 1-4. In one preferred arrangement, the system or software will calculate a similarity score for each object in the known tray based on how closely their features match the detected object. The object with the highest similarity score is considered the most likely match for the detected object. This can help identify objects that might have been initially misclassified due to their similarity to other things.

Such a process step 950 may result in certain system advantages. For example, by leveraging the known tray, the system can achieve a more accurate classification, especially when dealing with similar objects. In addition, the similarity score can help resolve cases where the initial classification was not entirely clear.

As just one example, the system may be configured to analyzing an image for use with a toolbox, such as the toolbox illustrated in FIG. 1. It might correctly identify screwdrivers and wrenches, but struggle between a socket wrench and an adjustable wrench. By comparing features with a known tray containing these specific wrench types, the system can refine its classification and identify the exact wrench with a higher degree of confidence. Classifying similar objects in a known tray is a way to leverage a reference set for more accurate and refined object identification, particularly when dealing with scenarios where similar objects might be present.

### Generate Confidence Report On Detected Objects

After step 950, the process 900 illustrated in FIG. 8 proceeds to step 953 which relates to a process step of generating one or more confidence reports. For example, in one arrangement, the software will generate a confidence report on each detected object. Generating a confidence report on each detected object can be important for a few key reasons. First, the AI models as disclosed and discussed herein are powerful predictors, but they are not absolute. They can present a certain degree of uncertainty in their predictions. A confidence report can help to quantify this uncertainty.

In addition, by providing a confidence score, the system becomes more transparent. Users can understand how certain the model is about its classifications. This can build trust in the system's outputs and allows users to make informed decisions based on the reported confidence level. Moreover, not all detections are equally important. A high confidence score on a critical object (like a critical tool for a certain technology or job assignment) might require immediate action. A lower confidence score might warrant further investigation or human verification before taking action.

Confidence reports allow system users to set thresholds for taking specific actions. For example, a particular system user might only trust detections with a confidence score above 80% and disregard anything lower.

Confidence reports can be used to identify areas where the model might struggle. For example, objects with consistently low confidence scores might indicate the need for retraining the model with more data for those specific objects.

In one arrangement, the confidence report might assign a numerical value (often a percentage between 0% and 100%) to each detected object. This value represents the model's estimated probability of being correct in its classification.

The following breakdown of how confidence scores might be interpreted could be implemented in one preferred arrangement.

High Confidence (e.g., 90%+): The model is very certain about its classification.

Medium Confidence (e.g., 50-80%): The model is somewhat certain, but there's still a chance of error.

Low Confidence (e.g., below 50%): The model is unsure about the classification. Human verification or disregarding the detection might be necessary.

Confidence reports can be essential for understanding the reliability of the presently disclosed AI-based image detection results. They allow users to make informed decisions, prioritize actions, and identify areas for model improvement.

### Generate Confidence Level of Detection On Different Light Condition

The process 900 proceeds to step 955 where the system generates a confidence level of detection on different light conditions. Generating a confidence level of detection specific to light conditions can be a valuable step in a comprehensive AI-based image detection model. There are two primary reasons underlying this potential valuation. The first is related to the reason that light variations can impact performance. Different lighting conditions can significantly affect how well an AI model performs object detection and recognition. For instance, low light, harsh shadows, or glare can reduce the clarity and detail in an image, making it harder for the model to accurately identify objects.

The second reason is related to transparency and context. By reporting a confidence level specific to the light conditions, the model provides valuable context for its overall confidence score. This allows users to understand how much the lighting might be influencing the detection accuracy.

There are a number of benefits of light-specific confidence levels. For example, users can consider the impact of lighting on the reported confidence and make better decisions based on the context. For example, a high overall confidence score might be less reliable in a low-light scenario compared to a well-lit situation.

In addition, light-specific confidence levels can demonstrate a more sophisticated understanding of the factors affecting accuracy. This fosters trust in the model's outputs. And by analyzing how confidence scores differ under varying light conditions, developers can identify areas where the model needs improvement and potentially calibrate it for better performance across different lighting scenarios.

In one preferred arrangement, the model might analyze various factors related to the image to estimate the impact of light conditions. These various factors are summarized below.

Light Intensity: Low light levels would generally lead to lower confidence scores.

Shadow Presence: Extensive shadows can obscure details, impacting confidence.

Glare or Reflections: These can introduce artifacts and confuse the model, lowering confidence.

By considering these factors, the model can be used to assign a separate confidence score specific to the light conditions affecting the image. Including a confidence level for light conditions provides a more nuanced and informative picture of the AI model's performance. This empowers users to make better decisions based on the context of the image and fosters trust in the overall detection process.

### Run AI Algorithm On Generated Confidence Report

After step 955, the process 900 illustrated in FIG. 8 proceeds to step 957 where the process performs the step of running the AI algorithm on the generated confidence report. Running an AI algorithm on the generated confidence report in an AI-based image processing system can provide several key advantages.

For example, by analyzing the confidence scores of detections, the system can assess the accuracy and reliability of its predictions. This can help in identifying instances where the model might be uncertain or prone to errors. In addition, reviewing confidence levels can pinpoint false positives and false negatives, enabling targeted improvements in the model. Moreover, analyzing confidence reports can provide feedback that helps in adjusting and retraining the model. For instance, segments or objects with low confidence scores can be flagged for further review and included in additional training cycles. And the system can adapt to varying conditions and contexts by dynamically adjusting its decision-making thresholds based on confidence levels.

In addition, high-confidence detections can be prioritized for immediate action, while low-confidence ones might require further verification or alternative processing steps. The system can also automatically tune its parameters (like threshold values) based on confidence scores, optimizing performance for different scenarios. By focusing computational resources on segments or detections with uncertain confidence levels, the system can more efficiently allocate resources. This can ensure that more critical areas receive the necessary processing power.

Human reviewers can be directed to only review low-confidence detections, reducing the workload and enhancing efficiency. By scrutinizing confidence scores, the system can reduce the impact of unreliable detections. This can involve implementing secondary checks or more sophisticated algorithms for low-confidence cases. Confidence scores can also help in mitigating risks by avoiding over-reliance on uncertain detections, which is crucial in safety-critical applications.

Running AI algorithms on confidence reports can also uncover patterns and trends in detection performance, providing insights into areas where the model performs well or poorly. Confidence data can be used in predictive models to anticipate future performance issues and preemptively address them.

Running an AI algorithm on the generated confidence report in an AI-based image processing system can be a crucial step for improving model accuracy, enabling adaptive learning, automating decision-making, optimizing resource allocation, enhancing robustness, facilitating user interaction, and providing advanced analytics. This step transforms raw confidence data into actionable insights, driving continuous improvement and reliability in AI image processing applications.

Extract Features from Each Detected Object

The process 900 next proceeds to step 960 which concerns the step of extracting features from detected objects. In one preferred arrangement, the system will extract features from each detected object. In an AI-based image detection model and system as herein disclosed, feature extraction can be an essential step that happens within the model, not as a separate process after the report is generated.

Feature extraction can be an important aspect of the presently disclosed software models. For example, to accurately classify objects such as hand tools (e.g., brand, model, etc.), the model needs to understand their key characteristics. Feature extraction helps achieve this by identifying and isolating these characteristics.

In addition, features act like a fingerprint for the object. By extracting features from both the detected object and the database entries (known objects, known trays, known hand tools), the model can compare and match them effectively for accurate classification.

In one arrangement of the presently disclosed systems and methods, the specific features extracted can vary depending on the model and the type of objects it is trained for.

However, in some arrangements, a few of the more common examples are summarized below.

Shape: Geometric properties like size, aspect ratio, corners, and edges.

Color: Distribution of colors across the object, dominant colors, and color patterns.

Texture: Smoothness, roughness, repetitive patterns on the object's surface.

Edges and Lines: Presence and arrangement of lines and edges within the object.

In one disclosed arrangement, the presently disclosed AI algorithms within the model use techniques like convolutional neural networks (CNNs) to analyze the image and automatically extract these features. CNNs are adept at identifying patterns and relationships between pixels in an image, allowing them to isolate these key characteristics of the object.

There are many benefits to using feature extraction. For example, features often remain consistent even under variations like lighting or viewpoint changes. This allows for more reliable matching and classification. Additionally, extracted features are a compressed representation of the object, making comparisons and computations within the model faster and more efficient.

Feature extraction can be an integral part of the AI algorithms within the presently disclosed image detection models. It allows the model to understand the objects it detects and compare them effectively with known objects for accurate classification, brand/model recognition, and overall improved performance.

### Detect Object From Detected Features

After process step 960, the process 900 proceeds to step 963 where the process detects the object from the detected features. And after process step 963, the process 900 moves to step 965 where the process gives a detection result based on all AI generated reports.

In an AI-based image processing system, providing detection results based on all AI-generated reports can offer several advantages. This comprehensive approach helps to ensure that the system's outputs are well-rounded, accurate, and robust. This can be important for numerous reasons.

For example, by aggregating all AI-generated reports, the system can provide a more holistic view of the detection results. This approach helps in capturing different aspects and features of the image, leading to more accurate and reliable results. Each report may highlight different elements or features of the image. Combining these reports helps to ensure that no critical information is missed.

Aggregating multiple reports also allows for cross-validation of detections. If multiple reports independently confirm a detection, the confidence in that detection increases. For example, if one report has errors or inconsistencies, other reports can help mitigate these issues by providing additional context and verification.

Moreover, different AI models or processing steps might perform better under varying conditions (e.g., lighting, occlusion). Combining results from all reports allows the system to adapt to these conditions and provide consistent performance. Aggregating results makes the system more robust to individual model failures or inaccuracies. It helps to ensure that the final output is less likely to be affected by a single point of failure.

Different AI-generated reports might focus on different features (e.g., shape, color, texture). Combining these reports enriches the feature set available for final detection, leading to more nuanced and accurate results. Aggregating various reports helps the system understand the context of detections better. For instance, combining edge detection with color segmentation can provide a clearer understanding of object boundaries.

By aggregating confidence scores from multiple reports, the system can provide a more reliable measure of certainty for each detection. This helps in making more informed decisions. The system can assign weights to different reports based on their confidence scores, ensuring that the final detection results reflect the most reliable information. By analyzing all reports, the system can focus computational resources on the most relevant and uncertain areas, optimizing processing time and effort. Aggregated reports can help prioritize which detections need further processing or human review, improving overall efficiency.

An AI-based image processing system that provides detection results based on all AI-generated reports benefits from comprehensive analysis, enhanced accuracy, robustness, rich feature extraction, reliable confidence measures, optimized resource utilization, and increased user trust and transparency. This approach leverages the strengths of multiple analyses to produce well-rounded and dependable detection results, ensuring high performance and reliability in various applications.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. An AI based inventory control system, comprising:
a first moveable drawer, the first moveable drawer moveable from a first position to a second position;
a first camera arranged to generate an image of an inventory item contained within the first moveable drawer;
an image processor in operative communication with the first camera, the image processor configured to process the image generated by the first camera; and
an AI engine performing recognition on the processed image received from the image processor.

2. The AI based inventory control system of claim 1, wherein the camera is configured to be movable along at least a portion of the first moveable drawer.

3. The AI based inventory control system of claim 1, wherein the AI engine performs object detection of the processed image received from the image processor.

4. The AI based inventory control system of claim 1, wherein the AI engine performs text recognition of the processed image received from the image processor.

5. The AI based inventory control system of claim 1, wherein the AI engine determines an inventory condition of the inventory item.

6. The AI based inventory control system of claim 1, wherein the AI engine identifies the inventory item residing in the first drawer and provides this image recognition information for further processing by the AI based inventory control system.

7. The AI based inventory control system of claim 1, wherein the inventory item residing in the first drawer comprises a hand tool.

8. An AI based system for training an inventory control system, the system comprising:
an AI graphics integrated circuit for operation of the AI based system;
a camera positioned over an inventory item;
a stepper motor operably coupled to the camera and controlled by the AI graphics integrated circuit, wherein the stepper motor is configured to move the camera to a plurality of positions;
a plurality of images of the inventory item taken by the camera as the camera is moved to the plurality of positions;
a processing software that processes each of the plurality of images of the inventory item;
a labeling system defined in part by the inventory item, the labeling system generating a plurality of labeled images;
a learning data set comprising the plurality of the labeled images of the inventory item; and
a CNN based computer vision model for receiving the learning data set of the inventory item,
wherein the CNN based computer vision model is trained to identify the inventory item based in part on the learning data set of the inventory item.

9. The AI based system of claim 8, wherein the CNN based computer vision model comprises a cloud-based computer vision model.

10. The AI based system of claim 9, wherein each of the plurality of images are labeled into a plurality of categories before being sent to the cloud.

11. The AI based system of claim 10, wherein each image is labeled with a part number before the image is sent to the cloud.

12. The AI based system of claim 11, wherein each inventory item is automatically labeled with the part number before the image is sent to the cloud.

13. The AI based system of claim 8, wherein the labeling system comprises a plurality of item classifiers.

14. The AI based system of claim 13, wherein the plurality of item classifiers comprises a hierarchical classification system.

15. The AI based system of claim 13, wherein the plurality of item classifiers are selected from a group of classifiers including category, type, class color, texture, pattern, contour, edge, writing, and dimension.

16. The AI based system of claim 8, wherein the processing software comprises an image segmentation algorithm that divides each of the plurality of images into regions that share a common characteristic.

17. The AI based system of claim 16, wherein the image segmentation algorithm converts each of the plurality of images to grayscale and imports the greyscale images into the CNN based computer vision model.

18. The AI based system of claim 8, wherein the inventory item is laid out on a size platform while the camera is provided at a predetermined height while creating the plurality of images, thereby creating a reference scale for the processing software.

19. The AI based system of claim 8, wherein the camera automatically takes the plurality of images at a plurality of different angles.

20. The AI based system of claim 8, wherein the integrated circuit comprises a SoC (system on a chip) designed for AI/graphics computations, and
wherein the SoC comprises a CPU, a GPU, and a memory controller into a single chip.
